(19) United States
(12) Patent Application Publication
(10) Pub. No.: US 2005/0079433 A1
(43) Pub. Date: Apr. 14, 2005

(54) Toner, method for manufacturing the toner, developer including the toner, container containing the toner, and image forming method and apparatus and process cartridge using the toner

(76) Inventors: Yohichiroh Watanabe, Fuji-shi (JP); Hiroshi Yamashita, Numazu-shi (JP); Tsunemi Sugiyama, Yokohama-shi (JP); Shinji Ohtani, Sunto-gun (JP); Takuya Saito, Numazu-shi (JP); Hidetoshi Kami, Numazu-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/957,629

(22) Filed: Oct. 5, 2004

(30) Foreign Application Priority Data
Oct. 8, 2003 (JP) 2003-349108

(51) Int. Cl. G03G 9/08

(52) U.S. Cl. 430/108.4; 430/125; 430/108.6; 430/108.1; 430/137.1

(57) ABSTRACT

An image forming method including forming an electrostatic latent image on an image bearing member; developing the electrostatic latent image with a developer including a toner to prepare a toner image on the image bearing member; transferring the toner image onto a receiving material; and cleaning the surface of the image bearing member with a cleaning blade; wherein a surface of the image bearing member has a friction coefficient of from 0.10 to 0.40, and wherein the toner has an average circularity of from 0.97 to 1.00 and includes toner particles and a particulate material having an average particle diameter of from 0.03 to 1 μm, wherein the particulate material is externally added to the toner particles by a wet method.

### BACKGROUND OF THE INVENTION

1. Field of the Invention

The present invention relates to a toner for use in developing an electrostatic latent image formed by a method such as electrophotography, electrostatic recording and electrostatic printing. In addition, the present invention also relates to a method for preparing the toner, a developer including the toner, a container containing the toner, and an image forming method, an image forming apparatus and a process cartridge using the toner.

2. Discussion of the Background

Electrophotographic image forming methods are widely used for image forming apparatus such as copiers, facsimile machines and laser printers. As described in U.S. Pat. No. 2,297,691 and published examined Japanese patent application No. 43-24748, the electrophotographic image forming methods typically include the following processes:
(1) charging an image bearing member (e.g., photoreceptors) (charging process);
(2) irradiating the photoreceptor with imagewise light to form an electrostatic latent image thereon (imagewise light irradiation process);
(3) developing the electrostatic latent image with a developer including a toner to form a toner image on the photoreceptor (developing process);
(4) transferring the toner image onto a receiving material such as paper optionally via an intermediate transfer medium (transfer process);
(5) fixing the toner image on the receiving material, for example, upon application of heat and pressure thereto (fixing process); and
(6) cleaning the surface of the photoreceptor (cleaning process).

Toner used for the image forming methods typically includes a binder such as styrene resins and polyester resins and a colorant and is typically prepared by a pulverization method in which the toner constituents are melted and kneaded, followed by pulverization and classification. However, when it is tried to prepare a toner having a small particle diameter using such a pulverization method to produce high quality images, problems which occur are that the manufacturing costs increase and/or a toner having such a small particle diameter cannot be prepared because there is a limit of pulverization ability of pulverizers.

Recently, in order to easily prepare a toner having a small particle diameter, polymerization methods such as suspension polymerization methods, emulsion polymerization/aggregation methods (described in, for example, Japanese patent No. 2,537,503 (i.e., published unexamined Japanese patent application No. 63-18625)), and dispersion polymerization methods have been proposed.

In addition, published unexamined Japanese patent application No. (hereinafter JP-A) 07-152202 and Japanese patent No. 3,141,783 (i.e., JP-A 10-26842) have disclosed polymer solution suspension methods in which a toner is prepared by dissolving or dispersing toner constituents in a volatile organic solvent, emulsifying the toner constituent liquid in an aqueous medium including a dispersant and removing the volatile solvent therefrom, resulting in formation of toner particles. The polymer solution suspension methods have advantages over the above-mentioned polymerization methods such that various resins can be used as the binder resin and polyester resins which can be preferably used for color toners because of being capable of imparting good transparency to the toner and producing toner images having smooth surface. However, these toners (i.e., toners prepared by the polymerization methods and the polymer solution suspension methods) typically have a spherical form, and therefore a cleaning problem occurs in that toner particles remaining on the surface of a photoreceptor cannot be well removed with a cleaning blade because the spherical toner particles rotate and easily pass through the nip between the cleaning blade and the photoreceptor.

In attempting to solve the cleaning problem, JP-As 05-66599, 05-88388, 06-282093, 08-87125, 11-212289, 2002-72510, 2002-107968 and 11-305470 have proposed techniques such that the friction coefficient of the photoreceptor used as an image bearing member is reduced by including a fluorine-containing resin therein to improve the cleanability and to improve the rolling-up of the cleaning blade. However, even when these techniques are used, it is hard to well remove the toner particles having a circularity not less than 0.97 from image bearing members. Specifically, even when a lubricant such as fatty acid metal salts is applied on the surface of a photoreceptor to reduce the friction coefficient of the photoreceptor, it is hard to well remove the toner particles having a circularity not less than 0.97 from the photoreceptor.

Because of these reasons, a need exists for a spherical toner having a small particle diameter and an image forming method by which high quality images can be produced using the spherical toner without causing the cleaning problem mentioned above.

### SUMMARY OF THE INVENTION

Accordingly, an object of the present invention is to provide an image forming method and an image forming apparatus by which high quality images can be produced using a spherical toner having a small particle diameter without causing the cleaning problem.

Another object of the present invention is to provide a toner which has a spherical form and can produce high quality images without causing the cleaning problem.

Yet another object of the present invention is to provide a method for efficiently manufacture the toner.

Briefly these objects and other objects of the present invention as hereinafter will become more readily apparent can be attained by an image forming method including the steps of:
forming an electrostatic latent image on an image bearing member;
developing the electrostatic latent image with a developer including a toner to prepare a toner image on the image bearing member;
transferring the toner image onto a receiving material; and
cleaning the surface of the image bearing member with a cleaning blade;
wherein the surface of the image bearing member has a static friction coefficient of from 0.10 to 0.40, and wherein the toner has an average circularity of from 0.97 to 1.00 and includes toner particles and a particulate material having an average particle diameter of from 0.03 to 1 μm, wherein the particulate material is externally added to the toner particles by a wet method (i.e., in a liquid).

The image bearing member preferably includes at least a material selected from the group consisting of fluorine-containing resins, derivatives of fluorine-containing resins, silicone resins, and derivatives of silicone resins.

As another aspect of the present invention, a toner is provided which has an average circularity of from 0.97 to 1.00 and which includes toner particles and a particulate material, wherein the particulate material is present on at least the surface of the toner particles and has an average particle diameter of from 0.03 to 1 μm, and wherein the particulate material is added to the toner particles by a wet method.

The particulate material is preferably an inorganic material which is preferably hydrophobized.

The toner preferably has a volume average particle diameter of from 1 to 8 μm.

The toner preferably includes a cleanability improving agent such as fatty acid metal salts and particulate polymers.

The toner preferably includes a fluidity improving agent which is added to the toner particles by a dry method.

The toner is preferably prepared by a method including a step of reacting a compound having an active hydrogen and a polymer in an aqueous medium to prepare a toner binder and to prepare toner particles.

As yet another aspect of the present invention, a method for preparing the toner mentioned above is provided which includes the steps of:
providing toner particles; and
adding the particulate material by a wet method in the presence of a surfactant having a polarity different from the polarity of the surface of the toner particles.

It is preferable that the method further includes a step of heating the toner particles after adding the particulate material thereto.

The surfactant is preferably a fluorine-containing surfactant.

As a further aspect of the present invention, a developer including the toner mentioned above and a carrier.

As a still further aspect of the present invention, a container containing the toner mentioned above is provided.

As a still further aspect of the present invention, an image forming apparatus is provided which includes:
an image bearing member configured to bear an electrostatic latent image thereon;
a developing device configured to develop the electrostatic latent image with a developer including the toner mentioned above; and
a cleaner configured to clean the surface of the image bearing member with a blade,
wherein the surface of the image bearing member has a static friction coefficient of from 0.10 to 0.40.

As a still further aspect of the present invention, a process cartridge is provided which is used for developing an electrostatic latent image formed on an image bearing member having a static friction coefficient of from 0.10 to 0.40 and which includes at least a developing device configured to develop the electrostatic latent image with a developer including the toner mentioned above and a housing.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic view illustrating an embodiment of the image forming apparatus of the present invention and for explaining the image forming method of the present invention;

FIG. 2 is a schematic view illustrating another embodiment of the image forming apparatus (tandem type color image forming apparatus) of the present invention and for explaining the image forming method of the present invention;

FIG. 3 is an enlarged view illustrating the main portion of the image forming apparatus illustrated in FIG. 2;

FIG. 4 is a schematic view illustrating an embodiment of the process cartridge of the present invention; and

FIG. 5 is a schematic view illustrating an embodiment of the instrument of measuring the friction coefficient of surface of a photoreceptor using an Euler belt method.

### DETAILED DESCRIPTION OF THE INVENTION

At first the toner of the present invention will be explained in detail.

The toner of the present invention has an average circularity of form 0.97 to 1.00 and includes toner particles and a particulate material with an average particle diameter of from 0.03 to 1 μm which is externally added to the toner particles by a wet method. The toner particle include at least a binder resin, and optionally includes a colorant, a charge controlling agent, a release agent, a fluidity improving agent, a non-reactive polyester resin and additives.

Then the toner constituents will be explained.

Particulate Material

The particulate material is not particularly limited, and proper materials are chosen among known materials such that the resultant toner fit for the purpose.

Suitable materials for use as the particulate material include inorganic materials such as oxides, titanates, sulfates, carbonates, nitrides, and other inorganic materials and organic materials.

Specific examples of the oxides include silicon dioxide (i.e., silica), titanium dioxide (i.e., titania), aluminum oxide (alumina), iron oxide, red iron oxide, copper oxide, zinc oxide, tin oxide, antimony trioxide, magnesium oxide, zirconium oxide, chromium oxide, cerium oxide, colloidal titanium oxide, colloidal silica, etc. Specific examples of the titanates include barium titanate, magnesium titanate, calcium titanate, strontium titanate, etc. Specific examples of the sulfates include barium sulfate, etc. Specific examples of the carbonates include barium carbonate, calcium carbonate, etc. Specific examples of the carbides include silicon carbide, etc. Specific examples of the nitrides include silicon nitride, etc. Other materials such as quartz sand, clay, mica, sand-lime, diatom earth, tricalcium phosphate and hydroxyapatite which is synthesized by reacting sodium phosphate with calcium chloride under a basic condition (i.e., in the presence of an alkali).

Among these materials, oxides are preferably used, and silicon dioxide, titanium dioxide and aluminum oxide are more preferably used. Particularly, silicon dioxide (silica) is preferable because of hardly releasing from the toner particles into an aqueous medium and having good dispersibility in organic solvents.

Suitable particulate organic materials include particles of polymers such as thermoplastic resins, and thermosetting resins. Specific examples of such polymers include polystyrene, methacrylate/acrylate copolymers, silicone resins, benzoguanamine resins, nylon resins, etc. Polymers prepared by a method such as soap-free emulsion polymerization methods, suspension polymerization methods, and dispersion polymerization methods can be preferably used as the particulate organic materials.

The particulate material has a number average particle diameter of from 0.03 to 1 μm, and preferably from 0.05 to 0.5 μm. When the particle diameter is too small, the toner tends to easily rotate, and thereby the toner has a poor cleanability. In contrast, when the particle diameter is too large, the particulate material is not uniformly adhered to the surface of the toner.

The number average particle diameter can be measured with any known particle diameter measuring instruments utilizing dynamic light scattering such as DLS-700 from Otsuka Electronics Co., Ltd. and COULTER N4 from Coulter Electronics Inc. When the particle diameter of a particulate inorganic material which has been subjected to a hydrophobizing treatment is measured, it is difficult to dissociate the aggregate of the hydrophobized inorganic material. Therefore, the particle diameter of such a particulate material is measured using a scanning electron microscope (SEM). Specifically, the particulate material is observed with a SEM and the particles diameters of at least 100 particles of the particulate material are measured to obtain the average particle diameter of the particulate material.

The content of the particulate material in the toner is preferably from 0.1 to 5.0% by weight, and more preferably from 0.1 to 3.0% by weight, based on the total weight of the toner. When the content is too low, the toner tends to easily rotate, and thereby the cleanability of the toner deteriorates. In contrast, when the content is too high, the fixability deteriorates.

The particle form of the toner of the present invention is not particularly limited. For example, the toner particles can have any form such as spherical forms, linear forms, and irregular forms.

The particulate material used for the toner of the present invention is preferably subjected to a hydrophobizing treatment to prevent deterioration of the fluidity and charge properties of the resultant toner even under high humidity conditions. By performing hydrophobizing treatment on the particulate material, hydrophilic groups (e.g., silanol group included in silica) present on the surface of the particulate material are replaced with hydrophobic groups, thereby improving the hydrophilic property of the particulate material. The degree of the hydrophobicity of the particulate material is not particularly limited. Namely, the degree of the hydrophobicity is determined depending on the purpose of the toner.

The method for hydrophobizing the particulate material is not particularly limited. For example, a method in which a particulate material is treated with a hydrophobizing agent and other methods can be used.

Suitable hydrophobizing agents for use in the hydrophobizing treatment include known hydrophobizing agents such as silane coupling agents, silylation agents, organic titanate coupling agents, aluminum coupling agents, silicone oils, etc.

Silane coupling agents having the following formula are preferably used as the hydrophobizing agent:
(O)x-Si(P)y-(A)z.
In the formula, Q represents a halogen atom, an amino group, or a hydrolyzing group such as alkoxy groups, and A represents an alkyl group or an aryl group. Character P represents an organic functional group such as —BOOC(R′)C═CH₂, —BNHR″, and BNH₂, wherein R′ represents an alkyl group, R″ represents an alkyl group or an aryl group, and B represents an alkylene group which can include a group such as —O—, —NH or —CO—.

Each of x and y is a positive integer and z is 0 or a positive integer, wherein x, y and z satisfy the following equation x+y+z=4.

Specific examples of the halogen atoms include fluorine atom, chlorine atom, bromine atom and iodine atom. Specific examples of the alkyl groups include a methyl group, an ethyl group, a propyl group, a butyl group, an isopropyl group, a pentyl group, a hexyl group, a cyclohexyl group, etc. Specific examples of the alkoxy groups include a methoxy group, an ethoxy group, a propoxy group, a butoxy group, etc. Specific examples of the aryl groups include a benzyl group. Specific examples of the alkylene groups include a methyl group, an ethyl group, a propylene group, etc. but are not limited thereto. These groups can be substituted with another group.

Specific examples of the silane coupling agents include vinyltrichlorosilane, vinyltrimethoxylsilane, vinyltriethoxylsilane, vinyltriacetoxylsilane, 2-(3,4-epoxycyclohexyl)ethyltrimethoxysilane, 3-glycidoxypropyltrimethoxysilane[γ-glycidoxypropyltrimethoxysilane], 3-glycidoxypropylmethyldiethoxysilane[γ-glycidoxypropylmethyldimethoxysilane], 3-glycidoxypropyltriethoxysilane, p-styryltrimethoxysilane, 3-methacryloxypropylmethyldimethoxysilane, 3-methacryloxypropyltrimethoxysilane[γ-methacryloxypropyltrimethoxysilane], 3-methacryloxypropylmethyldiethoxysilane, 3-methacryloxypropyltriethoxysilane, 3-acryloxypropyltrimethoxysilane, N-2(aminoethyl)-3-aminopropylmethyldimethoxysilane [γ-(2-aminoethyl)aminopropylmethyldimethoxysilane], N-2 (aminoethyl)-3-aminopropyltrimethoxysilane [γ-(2-aminoethyl)aminopropyltrimethoxysilane], N-2(aminoethyl)-3-aminopropyltriethoxysilane, 3-aminopropyltrimethoxysilane, 3-aminopropyltriethoxysilane, 3-triethoxysilyl-N-(1,3-dimethyl-butylidene)propylamine, N-phenyl-3-aminopropyltrimethoxysilane[γ-anilinopropyltrimethoxysilane], N-(vinylbenzyl)-2-aminoethyl-3-aminopropyltrimethoxysilane hydrochloride [N-β-(N-vinylbenzylaminoethyl)-γaminopropyltrimethoxysilane)hydrochloride], octadecyldimethyl(3-(trimethoxysilyl)propyl)ammonium chloride, 3-ureidopropyltriethoxysilane, 3-chloropropyltrimethoxysilane, 3-mercaptopropylmethyldimethoxysilane, bis(triethoxysilylpropyl)tetrasulfide, 3-isocyanatepropyltriethoxysilane, dimethyldichlorosilane, methyltrichlorosilane, methyldichlorosilane, trimethylchlorosilane, phenyltrichlorosilane, diphenyldichlorosilane, trifluoropropyltrichlorosilane, heptadecafluorodecylchlorosilane, etc.

Specific examples of the silazane include disilazane and trisilazane, but are not limited thereto.

These compounds can be used alone or in combination.

The particulate material is externally added to the toner by a wet method. When the particulate material is added to the toner by a dry method, the particulate material is easily released from the surface of the toner particles because the particulate material is not firmly fixed to the surface of the toner particles. In this case, when the particulate material has a large particle diameter, the particulate material is hardly adhered to the surface of the toner particles, and therefore good cleanability cannot be imparted to the toner.

When the particulate material is externally added to the toner by a wet method, the toner is preferably subjected to a heat treatment. In this case, the particulate material can be firmly fixed to the surface of the toner, and thereby the particulate material can be prevented from releasing from the toner surface.

Average Circularity

The toner of the present invention preferably has a circularity of from 0.97 to 1.00. When the circularity is too low, high quality images cannot be produced because the resultant toner images have a toner scattering problem and the transferability of the toner deteriorate.

In the present application, the circularity of a toner is determined as follows using a flow-type particle image analyzer FPIA-2100 from Sysmex Corp.:
(1) a suspension including toner particles to be measured is passed through a detection area formed on a plate in the measuring instrument; and
(2) the particles are optically detected by a CCD camera and then the shapes thereof are analyzed with an image analyzer.

The circularity of a particle is determined by the following equation:
Circularity=Cs/Cp
wherein Cp represents the length of the circumference of the projected image of a particle and Cs represents the length of the circumference of a circle having the same area as that of the projected image of the particle.
Toner Binder

The binder resin of the toner of the present invention is not particularly limited, and proper binder resins are chosen among known resin materials such that the resultant toner fit for the purpose. However, particulate resins which are prepared by a method including the step of reacting a compound having an active hydrogen and a polymer, which can reacted with the active hydrogen, in an aqueous medium are preferably used as the binder resin.

The binder resin of the toner of the present invention preferably has a weight average molecular weight not less than 10,000, more preferably from 20,000 to 10,000,000 and even more preferably from 30,000 to 1,000,000. When the molecular weight is too low, the resultant toner has a poor hot offset resistance.

The binder resin of the toner of the present invention preferably has a glass transition temperature of from 50 to 70° C., and more preferably from 55 to 65° C., to impart good preservability and low temperature fixability. When a urea-modified polyester resin is included in the toner as a binder resin, the resultant toner has good preservability even when the urea-modified polyester resin has a relatively low glass transition temperature compared to other binder resins.

The glass transition temperature (Tg) of a resin can be measured with a TG-DSC System TAS-100 from Rigaku Corporation. The method is as follows.
(1) about 10 mg of a sample, which is contained in an aluminum container, is set on a holder unit, and the holder unit is set in an electric furnace;
(2) the sample is heated from room temperature to 150° C. at a temperature rising speed of 10° C./min, followed by heating at 150° C. for 10 minutes and cooling to room temperature; and
(3) after the sample is allowed to settle at room temperature, the sample is heated again from room temperature to 150° C. at a temperature rising speed of 10° C./min to obtain a DSC curve.

The glass transition temperature (Tg) of the sample is determined using an analyzing system of TAS-100. The glass transition temperature is defined as the temperature at which the tangent line of the endothermic curve crosses the base line.

The toner of the present invention preferably has a storage modulus of 10,000 dyne/cm² at a temperature (TG′) not lower than 100° C., and more preferably from 110 to 200° C. when measured at a frequency of 20 Hz. When the temperature TG′ is too low, the toner has poor hot offset resistance.

In addition, the toner of the present invention preferably has a viscosity of 1,000 poise at a temperature (Tη) not higher than 180° C., and more preferably from 90 to 160° C. When the temperature Tη is too high, the low temperature fixability of the toner deteriorates.

Namely, in view of low temperature fixability and hot offset resistance, the temperature TG′ of the toner is preferably not lower than the temperature Tη, i.e., the difference (ΔT) between TG′ and Tη is not less than 0. Specifically, in view of preservability and low temperature fixability, the difference (ΔT=TG′−Tη) is preferably from 0 to 100° C., more preferably from 10 to 90° C., and even more preferably from 20 to 80° C.

The properties (such as fluidity) of the toner of the present invention directly depend on the properties of the binder resin included therein. Therefore the properties of the toner such as weight average molecular weight, glass transition temperature (Tg), storage modulus property (TG′) and difference (TG′−Tη) are the same as those of the binder resin used.

The binder resin is not particularly limited, and proper resins can be chosen among known materials such that the resultant toner fit for the purpose. Specific examples of the resins include vinyl resins, polyurethane resins, epoxy resins, polyester resins, polyamide resins, polyimide resins, silicone resins, phenolic resins, melamine resins, urea resins, aniline resins, ionomer resins, polycarbonate resins, etc. These resins can be used alone or in combination. Among these resins, polyester resins are preferably used.

Any known polyester resins are preferably used as the binder resin, but urea-modified polyester resins are more preferably used.

Urea-modified polyester resins are prepared by reacting an amine (B) (i.e., a compound having an active hydrogen) with a polyester prepolymer (A) having an isocyanate group (i.e., a polymer capable of reacting with an active hydrogen) in an aqueous medium.

The urea-modified polyester resins can include a urethane bonding as well as a urea bonding. The molar ratio (U1/U2) of the urea bonding (U1) to the urethane bonding (U2) is from 100/0 to 10/90, preferably from 80/20 to 20/80 and more preferably from 60/40 to 30/70. When the content of the urea bonding is too low, the hot offset resistance of the toner deteriorates.

Specific examples of suitable urea-modified polyester resins include the following.
(1) Mixtures of a urea-modified polyester resin which is prepared by reacting a polyester prepolymer, which is prepared by reacting a polycondensation product of an ethylene oxide (2 moles) adduct of bisphenol A and isophthalic acid with isophorone diisocyanate, with isophorone diamine; and a polycondensation product of an ethylene oxide (2 moles) adduct of bisphenol A and isophthalic acid;
(2) Mixtures of a urea-modified polyester resin which is prepared by reacting a polyester prepolymer, which is prepared by reacting a polycondensation product of an ethylene oxide (2 moles) adduct of bisphenol A and isophthalic acid with isophorone diisocyanate, with isophorone diamine; and a polycondensation product of an ethylene oxide (2 moles) adduct of bisphenol A and terephthalic acid;
(3) Mixtures of a urea-modified polyester resin which is prepared by reacting a polyester prepolymer, which is prepared by reacting a polycondensation product of an ethylene oxide (2 moles) adduct of bisphenol A, a propylene oxide (2 moles) adduct of bisphenol A and terephthalic acid with isophorone diisocyanate, with isophorone diamine; and a polycondensation product of an ethylene oxide (2 moles) adduct of bisphenol A, a propylene oxide (2 moles) adduct of bisphenol A and terephthalic acid;
(4) Mixtures of a urea-modified polyester resin which is prepared by reacting a polyester prepolymer, which is prepared by reacting a polycondensation product of an ethylene oxide (2 moles) adduct of bisphenol A, a propylene oxide (2 moles) adduct of bisphenol A and terephthalic acid with isophorone diisocyanate, with isophorone diamine; and a polycondensation product of a propylene oxide (2 moles) adduct of bisphenol A and terephthalic acid;
(5) Mixtures of a urea-modified polyester resin which is prepared by reacting a polyester prepolymer, which is prepared by reacting a polycondensation product of an ethylene oxide (2 moles) adduct of bisphenol A and terephthalic acid with isophorone diisocyanate, with hexamethylene diamine; and a polycondensation product of an ethylene oxide (2 moles) adduct of bisphenol A and terephthalic acid;
(6) Mixtures of a urea-modified polyester resin which is prepared by reacting a polyester prepolymer, which is prepared by reacting a polycondensation product of an ethylene oxide (2 moles) adduct of bisphenol A and terephthalic acid with isophorone diisocyanate, with hexamethylene diamine; and a polycondensation product of an ethylene oxide (2 moles) adduct of bisphenol A, a propylene oxide (2 moles) adduct of bisphenol A and terephthalic acid;
(7) Mixtures of a urea-modified polyester resin which is prepared by reacting a polyester prepolymer, which is prepared by reacting a polycondensation product of an ethylene oxide (2 moles) adduct of bisphenol A and terephthalic acid with isophorone diisocyanate, with ethylene diamine; and a polycondensation product of an ethylene oxide (2 moles) adduct of bisphenol A and terephthalic acid;
(8) Mixtures of a urea-modified polyester resin which is prepared by reacting a polyester prepolymer, which is prepared by reacting a polycondensation product of an ethylene oxide (2 moles) adduct of bisphenol A and isophthalic acid with diphenylmethane diisocyanate, with hexamethylene diamine; and a polycondensation product of an ethylene oxide (2 moles) adduct of bisphenol A and isophthalic acid;
(9) Mixtures of a urea-modified polyester resin which is prepared by reacting a polyester prepolymer, which is prepared by reacting a polycondensation product of an ethylene oxide (2 moles) adduct of bisphenol A, a propylene oxide (2 moles) adduct of bisphenol A, terephthalic acid and dodecenyl succinic anhydride with diphenylmethane diisocyanate, with hexamethylene diamine; and a polycondensation product of an ethylene oxide (2 moles) adduct of bisphenol A, a propylene oxide (2 moles) adduct of bisphenol A and terephthalic acid; and
(10) Mixtures of a urea-modified polyester resin which is prepared by reacting a polyester prepolymer, which is prepared by reacting a polycondensation product of an ethylene oxide (2 moles) adduct of bisphenol A and isophthalic acid with tolylene diisocyanate, with hexamethylene diamine; and a polycondensation product of an ethylene oxide (2 moles) adduct of bisphenol A and isophthalic acid.
   Compound Having an Active Hydrogen

The compound having an active hydrogen is used for crosslinking and/or extending the polymer capable of reacting with a compound having an active hydrogen.

Known compounds having an active hydrogen can be used as the compound and one ore more proper compounds are chosen such that the resultant toner fit for the purpose. For example, when an polyester prepolymer having an isocyanate group is used, amines are preferably used as the compound having an active hydrogen. This is because extension reaction and/or crosslinking reaction can be easily performed and thereby a polymer having high molecular weight can be produced.

Specific examples of the groups having an active hydrogen include hydroxyl groups (alcoholic hydroxyl groups and phenolic hydorxyl groups), amino groups, carboxyl groups, mercapto groups, etc. Compounds having two or more of these groups can also be used, and combinations of a compound having one of the groups and another compound having another of the groups can also be used. Among these groups, alcoholic hydroxyl groups are preferable.

Specific examples of the amines (B) include diamines (B1), polyamines (B2) having three or more amino groups, amino alcohols (B3), amino mercaptans (B4), amino acids (B5) and blocked amines (B6) in which the amines (B1-B5) mentioned above are blocked. These amines can be used alone or in combination. Among these amines, diamines (B1) and combinations of a diamine (B1) with a small amount of triamine (B2) are preferably used.

Specific examples of the diamines (B1) include aromatic diamines (e.g., phenylene diamine, diethyltoluene diamine and 4,4′-diaminodiphenyl methane); alicyclic diamines (e.g., 4,4′-diamino-3,3′-dimethyldicyclohexyl methane, diaminocyclohexane and isophoron diamine); aliphatic diamines (e.g., ethylene diamine, tetramethylene diamine and hexamethylene diamine); etc.

Specific examples of the polyamines (B2) having three or more amino groups include diethylene triamine, triethylene tetramine. Specific examples of the amino alcohols (B3) include ethanol amine and hydroxyethyl aniline. Specific examples of the amino mercaptan (B4) include aminoethyl mercaptan and aminopropyl mercaptan. Specific examples of the amino acids (5) include amino propionic acid and amino caproic acid. Specific examples of the blocked amines (B6) include ketimine compounds which are prepared by reacting one of the amines B1-B5 mentioned above with a ketone such as acetone, methyl ethyl ketone and methyl isobutyl ketone; oxazoline compounds, etc.

The molecular weight of the urea-modified polyesters can be controlled using an extension inhibitor, if desired. Specific examples of the extension inhibitor include monoamines (e.g., diethyl amine, dibutyl amine, butyl amine and lauryl amine), and blocked amines (i.e., ketimine compounds) prepared by blocking the monoamines mentioned above.

The mixing ratio (i.e., an equivalent ratio [NCO]/[NHx]) of (the [NCO] of) the prepolymer (A) having an isocyanate group to (the [NHx] of) the amine (B) is from 1/2 to 2/1, preferably from 1/1.5 to 1.5/1 and more preferably from 1.2/1 to 1/1.2. When the mixing ratio is too low, the molecular weight of the resultant urea-modified polyester decreases, resulting in deterioration of the hot offset resistance of the resultant toner.

Polymer Capable of Reacting Compound Having Active Hydrogen

Any known polymers having a group which can be reacted with a compound having an active hydrogen can be used as the polymer capable of reacting the compound (this polymer is hereinafter referred to as a prepolymer). Specific examples of the polymers include polyol resins, acrylic resins, polyester resins, epoxy resins, and derivatives thereof. These resins can be used alone or in combination. Among these resins, polyester resins are preferable.

Specific examples of the group of the prepolymer, which can be reacted with an active hydrogen, include isocyanate groups, epoxy groups, carboxyl groups, acid chloride groups, etc. Compounds having two or more of the groups and combinations of a compound having one of the groups and another compound having another of the groups can also be used. Among these groups, isocyanate groups can be preferably used.

Among the prepolymers, polyester resins (RMPE) having a group which can produce a urea bonding are preferably used because (1) the molecular weight of the resultant polymers can be easily controlled; and (2) the resultant toner can have good releasability and good fixability even when used for oil-less low temperature fixing devices.

Specific examples of the group which can produce a urea bonding include isocyanate groups. In particular, polyester prepolymers (A) having an isocyanate group are preferably used.

Polyester prepolymers (A) having an isocyanate group can be prepared by reacting a polycondensation product of a polyol (PO) and a polycarboxylic acid (PC) (i.e., a polyester resin having an active hydrogen atom) with a polyisocyanate (PIC).

Suitable polyols (PO) include diols (DIO), polyols (TO) having three or more hydroxyl groups, and mixtures of DIO and TO. Preferably, diols (DIO) or mixtures in which a small amount of a polyol (TO) is added to a diol (DIO) are used.

Specific examples of the diols (DIO) include alkylene glycols, alkylene ether glycols, alicyclic diols, alkylene oxide adducts of alicyclic diols, bisphenols, alkylene oxide adducts of bisphenols.

Suitable alkylene glycols include alkylene glycols having 2 to 12 carbon atoms, e.g., ethylene glycol, 1,2-propylene glycol, 1,3-propylene glycol, 1,4-butanediol and 1,6-hexanediol. Specific examples of the alkylene ether glycols include diethylene glycol, triethylene glycol, dipropylene glycol, polyethylene glycol, polypropylene glycol and polytetramethylene ether glycol. Specific examples of the alicyclic diols include 1,4-cyclohexane dimethanol and hydrogenated bisphenol A. Specific examples of the alkylene oxide adducts of alicyclic diols include adducts of the alicyclic diols mentioned above with an alkylene oxide (e.g., ethylene oxide, propylene oxide and butylene oxide). Specific examples of the bisphenols include bisphenol A, bisphenol F and bisphenol S. Specific examples of the alkylene oxide adducts of bisphenols include adducts of the bisphenols mentioned above with an alkylene oxide (e.g., ethylene oxide, propylene oxide and butylene oxide).

Among these compounds, alkylene glycols having from 2 to 12 carbon atoms and alkylene oxide adducts of bisphenols are preferable. More preferably, alkylene oxide adducts of bisphenols, or mixtures of an alkylene oxide adduct of bisphenols and an alkylene glycol having from 2 to 12 carbon atoms are used.

Specific examples of the polyols (TO) include aliphatic alcohols having three or more hydroxyl groups (e.g., glycerin, trimethylol ethane, trimethylol propane, pentaerythritol and sorbitol); polyphenols having three or more hydroxyl groups (trisphenol PA, phenol novolak and cresol novolak); adducts of the polyphenols mentioned above with an alkylene oxide such as ethylene oxide, propylene oxide and butylene oxide; etc.

When mixtures of a diol (DIO) and a polyol (TO) are used, the weight ratio (DIO/TO) is preferably 100/0.01 to 100/10, and more preferably from 100/0.01 to 100/1.

Suitable polycarboxylic acids (PC) include dicarboxylic acids (DIC), polycarboxylic acids (TC) having three or more carboxyl groups, and mixtures thereof. Among these compounds, dicarboxylic acids (DIC) or mixtures in which a small amount of a polycarboxylic acid (TC) is added to a dicarboxylic acid (DIC) are preferably used.

Specific examples of the dicarboxylic acids (DIC) include alkylene dicarboxylic acids (e.g., succinic acid, adipic acid and sebacic acid); alkenylene dicarboxylic acids (e.g., maleic acid and fumaric acid); aromatic dicarboxylic acids (e.g., phthalic acid, isophthalic acid, terephthalic acid and naphthalene dicarboxylic acids; etc. Among these compounds, alkenylene dicarboxylic acids having from 4 to 20 carbon atoms and aromatic dicarboxylic acids having from 8 to 20 carbon atoms are preferably used.

Specific examples of the polycarboxylic acids (TC) having three or more hydroxyl groups include aromatic polycarboxylic acids having from 9 to 20 carbon atoms (e.g., trimellitic acid and pyromellitic acid).

As the polycarboxylic acid (PC), anhydrides or lower alkyl esters (e.g., methyl esters, ethyl esters or isopropyl esters) of the polycarboxylic acids mentioned above can be used for the reaction with a polyol (PO).

When combinations of a dicarboxylic acid (DIC) and a polycarboxylic acid (TC) are used, the weight ratio (DIC/TC) is preferably 100/0.01 to 100/10, and more preferably from 100/0.01 to 100/1.

Suitable mixing ratio (i.e., an equivalent ratio [OH]/[COOH]) of (the [OH] of) a polyol (PO) to (the [COOH] of) a polycarboxylic acid (PC) is from 2/1 to 1/1, preferably from 1.5/1 to 1/1 and more preferably from 1.3/1 to 1.02/1. When the ratio is too high or too low, there is a case where the polycondensation reaction does not well proceed.

The content of the polyol unit in the polyester prepolymer (A) is preferably from 0.5 to 40% by weight, more preferably from 1 to 30% by weight, and even more preferably from 2 to 20% by weight. When the content is too low, the hot offset resistance deteriorates and a good combination of preservability and low temperature fixability cannot be imparted to the toner. When the content is too high, the low temperature fixability of the toner deteriorates.

Specific examples of the polyisocyanates (PIC) include aliphatic polyisocyanates (e.g., tetramethylene diisocyanate, hexamethylene diisocyanate and 2,6-diisocyanate methylcaproate); alicyclic polyisocyanates (e.g., isophorone diisocyanate and cyclohexylmethane diisocyanate); aromatic didicosycantes (e.g., tolylene diisocyanate and diphenylmethane diisocyanate); aromatic aliphatic diisocyanates (e.g., α,α,α′,α′-tetramethyl xylylene diisocyanate); isocyanurates (e.g., tris-isocyanatoalkyl-isocyanurate and triisocyanatocycloalkyl-isocyanurate); blocked polyisocyanates in which the polyisocyanates mentioned above are blocked with phenol derivatives, oximes or caprolactams; etc. These compounds can be used alone or in combination. Among these compounds, isophorone diisocyanate is preferable.

Suitable mixing ratio (i.e., [NCO]/[OH]) of (the [NCO] of) a polyisocyanate (PIC) to (the [OH] of) a polyester is from 5/1 to 1/1, preferably from 4/1 to 1.2/1 and more preferably from 3/1 to 1.5/1. When the [NCO]/[OH] ratio is too large, the low temperature fixability of the toner deteriorates. In contrast, when the ratio is too small, the content of the urea group in the modified polyesters decreases and thereby the hot-offset resistance of the toner deteriorates.

The content of the polyisocyanate (PIC) unit in the polyester prepolymer (A) having an isocyanate group is from 0.5 to 40% by weight, preferably from 1 to 30% by weight and more preferably from 2 to 20% by weight. When the content is too low, the hot offset resistance of the toner deteriorates and in addition a good combination of preservability and low temperature fixability cannot be imparted to the toner. In contrast, when the content is too high, the low temperature fixability of the toner deteriorates.

The number of the isocyanate group included in a molecule of the polyester prepolymer (A) is not less than 1, preferably from 1.5 to 3, and more preferably from 1.8 to 2.5. When the number of the isocyanate group is too small, the molecular weight of the resultant urea-modified polyester decreases and thereby the hot offset resistance deteriorate.

Aqueous Medium

The reaction of a polymer with a compound having an active hydrogen is performed in an aqueous medium.

Suitable aqueous media include water. In addition, other solvents which can be mixed with water can be added to water. Specific examples of such solvents include alcohols such as methanol, isopropanol, and ethylene glycol; dimethylformamide, tetrahydrofuran, cellosolves such as methyl cellosolve, lower ketones such as acetone and methyl ethyl ketone, etc.

Other Toner Constituents

The toner of the present invention can include other components such as cleanability improving agents, fluidity improving agents, release agents, colorants, particulate resins, non-reactive resins (such as unmodified polyester resins) other than the above-mentioned resins, charge controlling agents, magnetic materials, etc. These materials can be externally added to the toner particle by a dry method.

1) Cleanability Improving Agents

The toner preferably includes a cleanability improving agent which can impart good cleaning property to the toner such that the toner remaining on the surface of an image bearing member such as a photoreceptor even after a toner image is transferred can be easily removed. Specific examples of such a cleanability improving agent include fatty acids and metal salts of fatty acids such as stearic acid, zinc stearate, and calcium stearate; and particulate polymers such as polymethylmethacrylate and polystyrene, which are manufactured by a method such as soap-free emulsion polymerization methods.

Particulate resins having a relatively narrow particle diameter distribution and a volume average particle diameter of from 0.01 μm to 1 μm are preferably used as the cleanability improving agent.

2) Colorants

Known dyes and pigments can be used as the colorant of the toner of the present invention and one or more proper dyes and pigments are such that the resultant toner fit for the purpose.

Specific examples of the dyes and pigments include carbon black, Nigrosine dyes, black iron oxide, Naphthol Yellow S (C.I. 10316), Hansa Yellow 10G (C.I. 11710), Hansa Yellow 5G (C.I. 11660), Hansa Yellow G (C.I. 11680), Cadmium Yellow, yellow iron oxide, loess, chrome yellow, Titan Yellow, polyazo yellow, Oil Yellow, Hansa Yellow GR (C.I. 11730), Hansa Yellow A (C.I. 11735), Hansa Yellow RN(C.I. 11740), Hansa Yellow R(C.I. 12710), Pigment Yellow L (C.I. 12720), Benzidine Yellow G (C.I. 21095), Benzidine Yellow GR (C.I. 21100), Permanent Yellow NCG (C.I. 20040), Vulcan Fast Yellow 5G (C.I. 21220), Vulcan Fast Yellow R(C.I. 21135), Tartrazine Lake, Quinoline Yellow Lake, Anthrazane Yellow BGL (C.I. 60520), isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, Permanent Red F2R (C.I. 12310), Permanent Red F4R (C.I. 12335), Permanent Red FRL (C.I. 12440), Permanent Red FRLL (C.I. 12460), Permanent Red F4RH (C.I. 12420), Fast Scarlet VD, Vulcan Fast Rubine B (C.I. 12320), Brilliant Scarlet G, Lithol Rubine GX (C.I. 12825), Permanent Red F5R, Brilliant Carmine 6B, Pigment Scarlet 3B, Bordeaux 5B, Toluidine Maroon, Permanent Bordeaux F2K (C.I. 12170), Helio Bordeaux BL (C.I. 14830), Bordeaux 10B, Bon Maroon Light (C.I. 15825), Bon Maroon Medium (C.I. 15880), Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue RS (C.I. 69800), Indanthrene Blue BC (C.I. 69825), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and the like. These materials are used alone or in combination.

The content of the colorant in the toner is preferably from 1 to 20% by weight, and more preferably from 3 to 15% by weight of the toner. When the content is too low, the resultant toner images have low image density. In contrast, when the content is too high, the resultant toner has a poor fixability.

Master batches, which are complexes of a colorant with a resin, can be used as the colorant of the toner of the present invention.

Specific examples of the resins for use as the binder resin of the master batches include the modified and unmodified polyester resins as mentioned above, styrene polymers and substituted styrene polymers such as polystyrene, poly-p-chlorostyrene and polyvinyltoluene; styrene copolymers such as styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers and styrene-maleic acid ester copolymers; and other resins such as polymethyl methacrylate, polybutyl methacrylate, polyvinyl chloride, polyvinyl acetate, polyethylene, polypropylene, polyesters, epoxy resins, epoxy polyol resins, polyurethane resins, polyamide resins, polyvinyl butyral resins, acrylic resins, rosin, modified rosins, terpene resins, aliphatic or alicyclic hydrocarbon resins, aromatic petroleum resins, chlorinated paraffin, paraffin waxes, etc. These resins are used alone or in combination.

The master batches can be prepared by mixing one or more of the resins as mentioned above and one or more of the colorants as mentioned above and kneading the mixture while applying a high shearing force thereto. In this case, an organic solvent can be added to increase the interaction between the colorant and the resin. In addition, a flushing method in which an aqueous paste including a colorant and water is mixed with a resin dissolved in an organic solvent and kneaded so that the colorant is transferred to the resin side (i.e., the oil phase), and then the organic solvent (and water, if desired) is removed can be preferably used because the resultant wet cake can be used as it is without being dried. When performing the mixing and kneading process, dispersing devices capable of applying a high shearing force such as three roll mills can be preferably used.

3) Release Agent

Suitable materials for use as the release agent of the toner of the present invention include waxes.

Known waxes can be used for the toner of the present invention, and one or more proper waxes are used while considering the desired functions of the toner. Specific examples of the waxes include waxes having a carbonyl group; polyolefin waxes such as polyethylene waxes and polypropylene waxes; hydrocarbons having a long chain such as paraffin waxes and SASOL waxes. Specific examples of the waxes having a carbonyl group include esters of polyalkanoic acids (e.g., carnauba waxes, montan waxes, trimethylolpropane tribehenate, pentaerythritol tetrabehenate, pentaerythritol diacetate dibehenate, glycerin tribehenate and 1,18-octadecanediol distearate); polyalkanol esters (e.g., tristearyl trimellitate and distearyl maleate); polyalkanoic acid amides (e.g., ethylenediamine dibehenyl amide); polyalkylamides (e.g., trimellitic acid tristearylamide); and dialkyl ketones (e.g., distearyl ketone). Among these waxes having a carbonyl group, polyalkananoic acid esters are preferably used.

The melting point of the waxes for use in the toner of the present invention is from 40 to 160° C., preferably from 50 to 120° C., more preferably from 60 to 100° C. When the melting point of the wax used is too low, the preservability of the resultant toner deteriorates. In contrast, when the melting point is too high, the resultant toner tends to cause a cold offset problem in that a toner image adheres to a fixing roller when the toner image is fixed at a relatively low fixing temperature.

The content of a wax in the toner of the present invention is generally from 0 to 40% by weight, and preferably from 3 to 30% by weight. When the content is too high, the fluidity of the toner deteriorates, resulting in shortage of life of the developer.

4) Non-Reactive Polyester Resins

It is preferable to use a non-reactive polyester resin (UMPE) as the binder resin of the toner of the present invention. By using such an unmodified polyester resin, the low temperature fixability of the toner can be improved and in addition the toner can produce color images having high gloss.

Suitable materials for use as the non-reactive polyester resins include polycondensation products of a polyol (PO) with a polycarboxylic acid (PC). Specific examples of the polyol (PO) and polycarboxylic acid (PC) are mentioned above for use in the modified polyester resins. In addition, specific examples of the suitable polyol and polycarboxylic acid are also mentioned above. In the present application, not only unmodified polyester resins but also polyester resins including a bonding other than urea bonding can also be used as the unmodified polyester resin. For example, urethane-modified polyester resins can be used as the unmodified polyester resin.

When a combination of a modified polyester resin with a non-reactive polyester resin is used as the binder resin, it is preferable that the modified polyester resin (RMPE) is at least partially mixed with the non-reactive polyester resin to improve the low temperature fixability and hot offset resistance of the toner. Namely, it is preferable that the modified polyester resin (RMPE) has a molecular structure similar to that of the non-reactive polyester resin.

The non-reactive polyester resins for use in the toner of the present invention preferably have a weight average molecular weight (Mw) of form 1,000 to 30,000, and more preferably from 1,500 to 15,000 when Mw is determined by a gel permeation chromatography (GPC). When the molecular weight is too low, the preservability and hot offset resistance of the toner deteriorate. When the molecular weight is too high, the low temperature fixability of the toner deteriorates.

The non-reactive polyester resin preferably has an acid value of from 1 to 50 mgKOH/g, and more preferably from 5 to 30 mgKOH/g. When a non-reactive polyester having a high acid value is used, good negative charge property can be imparted to the toner.

When a non-reactive polyester resin (PE) is used in combination with a urea-modified polyester resin (RMPE), the mixing ratio (RMPE/PE) of the urea-modified polyester resin (RMPE) to the non-reactive polyester resin (PE) is preferably from 5/95 to 80/20 by weight, more preferably from 5/95 to 30/70 by weight, and even more preferably from 5/95 to 25/75 by weight. When the added amount of the non-reactive polyester resin is too large, the hot offset resistance of the toner deteriorates. When the added amount of the non-reactive polyester resin is too small, low temperature fixability of the toner deteriorates.

5) Charge Controlling Agent

Any known charge controlling agents can be used for the toner of the present invention to control the charge properties of the toner, and one or more proper charge controlling agents are chosen such that the toner fit for the purpose. Since colored charge controlling agents are used, the color tone of the resultant color toners may be changed, and therefore colorless or white charge controlling agents are preferably used.

Suitable examples of the charge controlling agents include Nigrosine dyes, triphenyl methane dyes, chromium-containing metal complex dyes, molybdic acid chelate pigments, Rhodamine dyes, alkoxyamines, quaternary ammonium salts, fluorine-modified quaternary ammonium salts, alkylamides, phosphor and it compounds, tungsten and its compounds, fluorine-containing activators, metal salts of salicylic acid, metal salts of salicylic acid derivatives, etc. These materials can be used alone or in combination.

Specific examples of the marketed charge controlling agents include BONTRON® 03 (Nigrosine dye), BONTRON® P-51 (quaternary ammonium salt), BONTRON® S-34 (metal-containing azo dye), BONTRON® E-82 (metal complex of oxynaphthoic acid), BONTRON® E-84 (metal complex of salicylic acid), and BONTRON® E-89 (phenolic condensation product), which are manufactured, by Orient Chemical Industries Co., Ltd.; TP-302 and TP-415 (molybdenum complex of quaternary ammonium salt), which are manufactured by Hodogaya Chemical Co., Ltd.; COPY CHARGE® PSY VP2038 (quaternary ammonium salt), COPY BLUE® (triphenyl methane derivative), COPY CHARGE® NEG VP2036 and COPY CHARGE® NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments, and polymers having a functional group such as a sulfonate group, a carboxyl group, a quaternary ammonium group, etc.

The charge controlling agent is kneaded together with a masterbatch, and the mixture is used for preparing toner particles. Alternatively, the charge controlling agent is dissolved or dispersed in an organic solvent together with other toner constituents so that the charge controlling agent is included in the resultant toner particles. It is also possible to adhere and fix a charge controlling agent to a surface of the toner particles which are previously prepared.

The content of the charge controlling agent in the toner of the present invention is changed depending on the variables such as choice of binder resin, presence of additives, and dispersion method. In general, the content the charge controlling agent is preferably from 0.1 to 10 parts by weight, and more preferably from 0.2 to 5 parts by weight, per 100 parts by weight of the binder resin included in the toner. When the content is too low, a good charge property cannot be imparted to the toner. When the content is too high, the charge quantity of the toner excessively increases, and thereby the electrostatic attraction between the developing roller and the toner increases, resulting in deterioration of fluidity and decrease of image density.

6) Magnetic Materials

The toner of the present invention can include a magnetic material. Suitable magnetic materials include iron powders, magnetites, ferrites, etc. White magnetic materials are preferably used for the toner of the present invention.

The form and particle size of the toner of the present invention is not particularly limited. However, it is preferable that the toner has a volume average particle diameter (Dv) of from 1 to 8 μm. When the average particle diameter is too small, the toner tends to adhere to the carrier when the two component developer is agitated for a long period of time in a developing device, resulting in deterioration of the charging ability of the carrier. In a case of one component developer, such a small toner tends to cause problems in that a film of the toner is formed on the surface of the developing roller and/or the toner adheres to the blade, which is configured to form a thin layer of the toner on the surface of the developing roller. In contrast, when the particle diameter of the toner is too large, it becomes difficult to produce high quality and high definition images.

The ratio (Dv/Dn) of the volume average particle diameter (Dv) of the toner to the number average particle diameter (Dn) thereof is preferably from 1.00 to 1.25, and more preferably from 1.10 to 1.20. When the ratio (Dv/Dn) is too large, it becomes difficult to produce high quality and high definition images, and a problem in that the particle diameter distribution of the toner varies occurs when the toner is used while replenished to the developing device.

The volume average particle diameter (Dv), and the ratio (Dv/Dn) of a toner can be measured using a particle diameter measuring instrument such as COULTER COUNTER TAII from Coulter Electronics, Inc.

The toner of the present invention preferably has the following thermal properties such as softening point (Ts), flow beginning temperature (Tfb) and ½-method softening point (T_{1/2}). Such thermal properties of a toner can be determined from a flow curve obtained by subjecting the toner a heat analysis using a flow tester CFT-500 manufactured by Shimadzu Corp.

The softening point (Ts) of the toner of the present invention is preferably not lower than 50° C., and more preferably from 60 to 100° C. When the softening point is too low, the preservability of the toner deteriorates.

The flow beginning temperature (Tfb) is preferably not lower than 60° C., and more preferably from 70 to 150° C. When the flow beginning temperature is too low, the offset resistance of the toner deteriorates.

The ½-method softening point of the toner is preferably not lower than 70° C., and more preferably from 90 to 170° C. When the ½-method softening point is too low, the offset resistance of the toner deteriorates.

The color of the toner of the present invention is not particularly limited. However, it is preferable to use a black toner, a yellow toner, a magenta toner and a cyan toner to produce full color images. In order to produce such color toners, one or more proper colorants are chosen among such colorants as mentioned above.

The toner of the present invention is preferably used for an image bearing member having a surface with a friction coefficient of from 0.1 to 0.4, and preferably from 0.1 to 0.3. When the friction coefficient is too low, the toner images tend to be dislocated due to slipping of the toner images. When the friction coefficient is too high, toner particles remaining on the image bearing member cannot be well removed with a cleaning blade because the toner particles rotate on the surface of the image bearing member.

In the present invention, the friction coefficient of the surface of the image bearing member means the coefficient of static friction and is measured by an Euler belt method. The Euler belt method will be explained.

The measuring instrument for use in the Euler belt method is illustrated in FIG. 5.

A character S′ denotes a paper TYPE 6200 from Ricoh Co., Ltd., which has a size of 30 mm in width and 210 mm in length. In this case, the longitudinal direction of the paper is perpendicular to the machine direction of the paper manufacturing machine. Two hooks are set at each end of the paper S′, and a load W (100 g) is set at one hook and a digital force gauge DS is set at the other hook. The paper S′ is set in the measuring instrument so as to contact a photoreceptor 1A (an image bearing member) which is held by a block B, as illustrated in FIG. 5. The paper S′ contacts one fourth of the peripheral surface of the photoreceptor. The paper S′ is pulled slowly with the digital force gauge DS. Provided when a force at which the paper S′ starts to move is F, the coefficient of static friction of the photoreceptor 1A is determined by the following equation:
μs=(π/2)ln(F/w)
wherein μs is the coefficient of static friction of the photoreceptor 1A, F is the measured value of the force, and w is the load.

When the friction coefficient of a belt-form photoreceptor, which cannot maintain a cylindrical form, is measured after winding the belt on a cylinder.

By using the toner of the present invention is used for image forming such as electrophotographic image forming, the toner particles remaining on the image bearing member even after the transferring process can be easily removed with a cleaning blade from the surface of the image bearing member without causing a problem in that the toner particles pass through the cleaning blade while rotating. Therefore, high quality and high definition images can be produced.

The toner may be contained in a toner container to be used for image forming apparatus. The toner can be used as a one component developer and can be combined with a carrier to be used as a two component developer. As mentioned below, the toner can be preferably used for the image forming apparatus and the process cartridge of the present invention.

The toner of the present invention can be prepared by a method such as pulverization methods, suspension polymerization methods, emulsion polymerization/aggregation methods and polymer solution suspension methods. However, the toner of the present invention is preferably prepared by the following method.

Preferred Method for Preparing the Toner

The method for preparing the toner of the present invention includes at least a step of externally adding a particulate material to the toner particles in a liquid including a surfactant having a polarity different from the polarity of the surface of the toner particles.

The method for preparing the toner particles is not particularly limited, and methods such as pulverization methods, suspension polymerization methods, emulsion polymerization/aggregation methods, polymer solution suspension methods and other methods can be used.

The pulverization methods typically include the following processes:
(1) toner constituents such as binder resins and colorants are melted and kneaded;
(2) the kneaded mixture is cooled and pulverized; and
(3) the pulverized mixture is classified to prepare toner particles.

In order to prepare toner particles having a circularity of from 0.97 to 1.00, a mechanical force can be applied to the toner particles using a machine such as HYBRIDIZER and MECHANOFUSION.

The suspension polymerization methods typically include the following processes:
(1) an oil soluble polymerization initiator, one or more polymerizable monomers, a colorant, a release agent, etc., are dissolved or dispersed in an organic solvent to prepare an oil phase liquid;
(2) dispersing the oil phase liquid in an aqueous medium including a dispersant to prepare an emulsion; and
(3) polymerizing the monomers in the oil phase to prepare toner particles.

The emulsion polymerization/aggregation methods typically include the following processes:
(1) a water soluble polymerization initiator and one or more polymerizable monomers are emulsified in water using a surfactant to prepare an emulsion;
(2) a colorant, release agent, etc., are dispersed in water to prepare a dispersion;
(3) the emulsion and the dispersion are mixed so that the particles are aggregated so as to have a particle diameter suitable for the toner; and
(4) the aggregated particles are heated so as to be fused, resulting in formation of toner particles.

Specific examples of the other manufacturing methods include a spray drying method in which a toner constituent mixture liquid is sprayed using a spray drying device to remove the solvent therefrom and to prepare toner particles; and a method in which toner constituent mixture is heated in an aqueous medium so as to have a spherical form.

The toner of the present invention is preferably prepared by a method including the steps of dispersing a compound having an active hydrogen and a polymer which can be reacted with the compound in an aqueous medium; and reacting the compound and the polymer to prepare the binder resin and to prepare toner particles. Hereinafter this process is referred to as toner binder preparing process.

Then the toner binder preparing process will be explained.

In the toner binder preparing process, for example, the following operations are performed:
(1) the aqueous medium is prepared;
(2) an oil phase liquid including the compound having an active hydrogen atom and the polymer;
(3) the oil phase liquid is dispersed (emulsified) in the aqueous medium; and
(4) other operations such as synthesis of the polymer and the compound having an active hydrogen.

In the aqueous medium preparation process, one or more of the particulate materials mentioned above are dispersed in an aqueous medium. The content of the particulate materials in the aqueous medium is preferably from 0.5 to 10% by weight.

In the oil phase liquid preparation process, a compound having an active hydrogen atom, a polymer which can be reacted with the compound and other toner constituents such as colorants, release agents, charge controlling agents, and non-reactive polyester resins are dissolved or dispersed in an organic solvent. The toner constituents other than the polymer can be added to the aqueous medium in the aqueous medium preparation process. Alternatively the toner constituents can be added to the aqueous medium together with the oil phase liquid including an organic solvent and the polymer.

Suitable organic solvents for use in the oil phase liquid preparation process include any known organic solvents which can dissolve or disperse such toner constituents as mentioned above. Since it is preferable for the solvent to be easily removed from the emulsion, the solvent preferably has a boiling point lower than 100° C.

Specific examples of the organic solvents include toluene, xylene, benzene, carbon tetrachloride, methylene chloride, 1,2-dichloroethane, 1,1,2-trichloroethane, trichloroethylene, chloroform, monochlorobenzene, methyl acetate, dichloroethylidene, methyl acetate, ethyl acetate, methyl ethyl ketone, methyl isobutyl ketone, etc. Among these solvents, ethyl acetate, toluene, xylene, benzene, methylene chloride, 1,2-dichloroethane, chloroform, and carbon tetrachloride are preferable. These solvents can be used alone or in combination. In addition, a solvent which can be mixed with the aqueous medium can be used in combination therewith, to adjust the particle form of the toner particles.

The added amount of the organic solvent is from 10 to 900 parts by weight, preferably from 60 to 140 parts by weight, and more preferably from 80 to 120 parts by weight, per 100 parts by weight of the total weight of the toner constituents.

In the oil phase emulsification process, the oil phase liquid prepared above is dispersed and emulsified in the aqueous medium prepared above. In this case, the compound having an active hydrogen atom and the polymer are subjected to an extension reaction and/or a crosslinking reaction. Thus the toner binder is prepared.

The method of adding the compound and the polymer is not limited to the method mentioned above. For example, the following methods can also be used:
(1) an organic solvent liquid including the polymer (such as a polyester prepolymer including an isocyanate group) is added to an aqueous medium including a particulate material together with the compound (such as an amine) to prepare an emulsion and to perform an extension and/or a crosslinking reaction;
(2) an organic solvent liquid including the polymer is added to an aqueous medium including a particulate material and the compound to prepare an emulsion and to perform an extension and/or a crosslinking reaction; and
(3) an organic solvent liquid including the polymer is added to an aqueous medium including a particulate material and then the compound is added to the mixture to prepare an emulsion and to perform an extension and/or a crosslinking reaction.

In the method (3), a modified polyester is mainly prepared at the surface of the toner particles and therefore it is possible to form concentration gradient of the polyester resin in the depth direction of the toner particles.

The reaction conditions are not particularly limited, and the conditions are determined depending on the reactivity of the compound and the polymer used. The reaction time is generally from 10 minutes to 40 hours, and preferably from 2 to 24 hours. The reaction temperature is generally from 0 to 150° C., and preferably from 40 to 98° C.

In order to prepare a stable dispersion in which the oil phase liquid including the prepolymer and other toner constituents (e.g., colorants, release agents, charge controlling agents, and non-reactive polyester resins) in an aqueous medium, it is preferable to mix the oil phase liquid and the aqueous phase while applying a shearing force thereto.

The dispersing operation is not particularly limited, and known mixers and dispersion machines such as homogenizers which use a high speed rotor and a stator, high pressure homogenizers, ball mills, bead mills, sand mills, low shearing type dispersion machines, high shearing type dispersion machines, friction type dispersion machines, high pressure jet type dispersion machines and ultrasonic dispersion machine can be used.

Among these dispersion machines, high shearing type dispersion machines are preferably used because the average particle diameter of the particles in the emulsion can be controlled so as to be from 2 to 20 μm.

Specific examples of the marketed dispersion machines of this type include continuous dispersion machines such as ULTRA-TURRAX® (from IKA Japan) POLYTRON® (from KINEMATICA AG), TK AUTO HOMO MIXER® (from Tokushu Kika Kogyo Co., Ltd.), EBARA MILDER® (from Ebara Corporation), TK PIPELINE HOMO MIXER® (from Tokushu Kika Kogyo Co., Ltd.), TK HOMOMIC LINE MILL® (from Tokushu Kika Kogyo Co., Ltd.), colloid mill (from SHINKO PANTEC CO., LTD.), slasher, trigonal wet pulverizer (from Mitsui Miike Machinery Co., Ltd.), CAVITRON® (from Eurotec), and FINE FLOW MILL® (from Pacific Machinery & Engineering Co., Ltd.); and batch type emulsifiers or batch/continuous emulsifiers such as CLEARMIX® (from M Technique) and FILMICS (from Tokushu Kika Kogyo Co., Ltd.).

When high shearing type dispersion machines are used, the rotation speed of rotors is not particularly limited, but the rotation speed is generally from 1,000 to 30,000 rpm and preferably from 5,000 to 20,000 rpm. In addition, the dispersion time is also not particularly limited, but the dispersion time is generally from 0.1 to 5 minutes. The temperature in the dispersing process is generally 0 to 150° C. (under pressure), and preferably from 40 to 98° C. The processing temperature is preferably as high as possible because the viscosity of the dispersion decreases and thereby the dispersing operation can be easily performed.

In the emulsification process, the weight ratio (T/M) of the constituents (T) to the aqueous medium (M) is typically from 100/50 to 100/2,000, and preferably from 100/100 to 100/1,000. When the ratio is too large (i.e., the quantity of the aqueous medium is small), the dispersion state of the toner constituents in the aqueous medium is not satisfactory, and thereby the resultant toner particles do not have a desired particle diameter. In contrast, when the ratio is too small, the manufacturing costs increase.

When the emulsion is prepared, a dispersant can be preferably used so that the resultant emulsion includes particles having a sharp particle diameter distribution and the emulsion has good dispersion stability.

Suitable dispersants include surfactants, inorganic dispersants which are hardly soluble in water, polymer protection colloids, etc. These dispersants can be used alone or in combination. Among these dispersants, surfactants are preferably used.

Specific examples of the surfactants include anionic surfactants, cationic surfactants, nonionic surfactants, and ampholytic surfactants.

Suitable anionic surfactants include alkylbenzene sulfonic acid salts, α-olefin sulfonic acid salts, and phosphoric acid salts. It is preferable to use fluorine-containing surfactants.

Specific examples of anionic surfactants having a fluoroalkyl group include fluoroalkyl carboxylic acids having from 2 to 10 carbon atoms and their metal salts, disodium perfluorooctanesulfonylglutamate, sodium 3-{omega-fluoroalkyl(C6-C11)oxy}-1-alkyl(C3-C4) sulfonate, sodium 3-{omega-fluoroalkanoyl(C6-C8)-N-ethylamino}-1-propanesulfonate, fluoroalkyl(C11-C20) carboxylic acids and their metal salts, perfluoroalkylcarboxylic acids and their metal salts, perfluoroalkyl(C4-C12)sulfonate and their metal salts, perfluorooctanesulfonic acid diethanol amides, N-propyl-N-(2-hydroxyethyl)perfluorooctanesulfone amide, perfluoroalkyl(C6-C10)sulfoneamidepropyltrimethylammonium salts, salts of perfluoroalkyl(C6-C10)-N-ethylsulfonyl glycin, monoperfluoroalkyl(C6-C16)ethylphosphates, etc.

Specific examples of the marketed products of such surfactants including a fluoroalkyl group include SARFRON® S-111, S-112 and S-113, which are manufactured by Asahi Glass Co., Ltd.; FLUORAD® FC-93, FC-95, FC-98 and FC-129, which are manufactured by Sumitomo 3M Ltd.; UNIDYNE® DS-101 and DS-102, which are manufactured by Daikin Industries, Ltd.; MEGAFACE® F-110, F-120, F-113, F-191, F-812 and F-833 which are manufactured by Dainippon Ink and Chemicals, Inc.; ECTOP® EF-102, 103, 104, 105, 112, 123A, 306A, 501, 201 and 204, which are manufactured by Tohchem Products Co., Ltd.; FUTARGENT® F-100 and F150 manufactured by Neos; etc.

Suitable cationic surfactants include amine salt based surfactants and quaternary ammonium salt based surfactants.

Specific examples of the amine salt based surfactants include alkyl amine salts, aminoalcohol fatty acid derivatives, polyamine fatty acid derivatives and imidazoline.

Specific examples of the quaternary ammonium salt based surfactants include alkyltrimethyl ammonium salts, dialkyldimethyl ammonium salts, alkyldimethyl benzyl ammonium salts, pyridinium salts, alkyl isoquinolinium salts and benzethonium chloride. It is preferable to use cationic surfactants having a fluoroalkyl group.

Specific examples of the cationic surfactants having a fluoroalkyl group include primary, secondary and tertiary aliphatic amino acids having a fluoroalkyl group, perfluoroalkyl(C6-C10)sulfoneamidepropyltrimethylammonium salts, benzalkonium salts, benzetonium chloride, pyridinium salts, imidazolinium salts, etc.

Specific examples of the marketed products thereof include SARFRON® S-121 (from Asahi Glass Co., Ltd.); FLUORAD® FC-135 (from Sumitomo 3M Ltd.); UNIDYNE® DS-202 (from Daikin Industries, Ltd.); MEGAFACE® F-150 and F-824 (from Dainippon Ink and Chemicals, Inc.); ECTOP® EF-132 (from Tohchem Products Co., Ltd.); FUTARGENT® F-300 (from Neos); etc.

Suitable nonionic surfactants include fatty acid amide derivatives, and polyhydric alcohol derivatives.

Suitable ampholytic surfactants include alanine, dodecyldi (aminoethyl)glycin, di (octylaminoethyle) glycin, and N-alkyl-N,N-dimethylammonium betaine.

Suitable inorganic dispersants which is hardly soluble in water include tricalcium phosphate, calcium carbonate, titanium oxide, colloidal silica, hydroxyapatite, etc.

Suitable polymer protection colloids include homopolymers and copolymers of acids, acrylic monomers having a hydroxyl group, vinyl alcohol and ethers of vinyl alcohol, esters of vinyl alcohol and compounds having a carboxyl group, amides and methylol compounds thereof, chlorides, and monomers having a nitrogen atom; polyoxyethylene compounds; and cellulose compounds.

Specific examples of the acids include acrylic acid, methacrylic acid, α-cyanoacrylic acid, α-cyanomethacrylic acid, itaconic acid, crotonic acid, fumaric acid, maleic acid and maleic anhydride. Specific examples of the acrylic monomers having a hydroxyl group include β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycolmonoacrylic acid esters, diethyleneglycolmonomethacrylic acid esters, glycerinmonoacrylic acid esters, N-methylolacrylamide and N-methylolmethacrylamide. Specific examples of the vinyl alcohol and its ethers include vinyl methyl ether, vinyl ethyl ether and vinyl propyl ether. Specific examples of the esters of vinyl alcohol with a compound having a carboxyl group include vinyl acetate, vinyl propionate and vinyl butyrate. Specific examples of the acrylic amides include acrylamide, methacrylamide, diacetoneacrylamide and their methylol compounds. Specific examples of the chlorides include acrylic acid chloride and methacrylic acid chloride. Specific examples of the monomers having a nitrogen atom or an alicyclic ring having a nitrogen atom include vinyl pyridine, vinyl pyrrolidone, vinyl imidazole and ethylene imine.

Specific examples of the polyoxyethylene compounds include polyoxyethylene, polyoxypropylene, polyoxyethylenealkyl amines, polyoxypropylenealkyl amines, polyoxyethylenealkyl amides, polyoxypropylenealkyl amides, polyoxyethylene nonylphenyl ethers, polyoxyethylene laurylphenyl ethers, polyoxyethylene stearylphenyl esters, and polyoxyethylene nonylphenyl esters. Specific examples of the cellulose compounds include methyl cellulose, hydroxyethyl cellulose and hydroxypropyl cellulose.

In the emulsification/dispersion process, a dispersion stabilizer can be used if desired. Specific examples of the dispersion stabilizers include compounds which are soluble in acids and alkalis, such as calcium phosphate.

When such compounds are used as a dispersion stabilizer, the resultant toner particles are preferably mixed with an acid such as hydrochloric acid, followed by washing with water to remove calcium phosphate from the toner particles. In addition, calcium phosphate can be removed using a zymolytic method.

In the emulsification process, a known catalyst can optionally be used for crosslinking and/or extending the prepolymer. Specific examples of the catalyst include dibutyltin laurate and dioctyltin laurate.

In order to remove an organic solvent from the thus prepared emulsion, (1) a method in which the emulsion is gradually heated to perfectly evaporate the organic solvent included in the drops of the oil phase liquid; (2) a method in which the emulsion is sprayed in a dry environment to dry the organic solvent in the drops of the oil phase liquid and water in the dispersion, resulting in formation of toner particles; or other methods can be used.

In this case, gases which are prepared by heating air, nitrogen, carbon dioxide or incineration gas, are generally used for the dry environment in which the emulsion is sprayed. The gas is preferably heated to a temperature higher than the boiling point of the solvent having the highest boiling point among the solvents used. In order to prepare toner particles having targeted qualities, it is preferable to perform drying for a short period of time using a spray drier, belt drier, rotary kiln or the like.

The thus prepared toner particles can be washed and dried. When the thus prepared toner particles have a wide particle diameter distribution even after the particles are subjected to a washing treatment and a drying treatment, the toner particles are preferably subjected to a classification treatment using a cyclone, a decanter or a method utilizing centrifuge to remove fine particles therefrom. In this case, it is preferable to perform the classification operation in the liquid having the particles in view of efficiency. Fine particles and coarse particles which are removed in the classification process can be reused for the binder preparation process.

Wet External Addition Process

In this process, one or more of the particulate materials mentioned above are externally added to the thus prepared toner particles in the presence of a surfactant having a polarity different from the polarity of the surface of the toner particles by a wet method.

Since the toner particles are formed in the aqueous medium, this process can be easily performed in the aqueous medium. In this case, the surfactant included in the aqueous dispersion including the toner particles is preferably removed by subjecting the dispersion to filtering or centrifugal separation. The thus prepared cake or slurry is re-dispersed in an aqueous medium to prepare a dispersion of the toner particles, and the particulate material is added to the thus prepared dispersion.

The weight ratio (P/T) of the particulate material (P) to the toner particles (T) is preferably from 0.01/100 to 5/100.

The surfactant used for this wet external addition process has a polarity different from (opposite to) the polarity of the surface of the toner particles. When such a surfactant is used, the particulate material is uniformly and securely fixed on the surface of the toner particles, and thereby good cleanability can be imparted to the resultant toner. In addition, charges of the particulate material in the aqueous medium can be neutralized, and thereby the particulate material can be efficiently adhered to the surface of the toner particles.

After this external addition process, the toner particles on which the particulate material is adhered are preferably heated to securely fix the particulate material to the toner surface (i.e., to prevent the particulate material from releasing from the toner surface).

The heating temperature is preferably not lower than the glass transition temperature (Tg) of the binder resin of the toner, and preferably from a temperature 5 degree higher than the Tg to a temperature 30 degree higher than the Tg. The heating operation can be performed after the particulate material is dried while aggregation of the particulate material is prevented.

The surfactant having a polarity different from the polarity of the toner surface is not particularly limited. For example, one or more of anionic, cationic, nonionic and ampholytic surfactants can be used.

Specific examples of the anionic surfactants include alkylbenzensulfonates, α-olefinsulfonate, phosphoric acid esters, etc.

Specific examples of the cationic surfactants include amine-based surfactants such as alkyl amine salts, aminoalcohol fatty acid derivatives, polyamine fatty acid derivatives and imidazoline; quaternary ammonium salt based surfactants such as alkyltrimethyl ammonium salts, dialkyldimethyl ammonium salts, alkyldimethyl benzyl ammonium salts, pyridinium salts, alkyl isoquinolinium salts and benzethonium chloride; etc.

Specific examples of the nonionic surfactants include fatty acid amide derivatives, poyhydric alcohol derivatives, etc.

Specific examples of the ampholytic surfactants include alanine, dodecyldi(aminoethyl)glycin, di(octylaminoethyle)glycin, and N-alkyl-N,N-dimethylammonium betaine.

These surfactants can be used alone or in combination.

The content of the surfactant is preferably from 0.1 to 10% by weight based on the total weight of the aqueous medium.

Among these surfactants, fluorine-containing surfactants such as anionic surfactants including a fluoroalkyl group and cationic surfactants including a fluoroalkyl group are preferably used because the resultant toner has good charging ability and good charge rising property.

Specific examples of the anionic surfactants including a fluoroalkyl group and cationic surfactants including a fluoroalkyl group are mentioned above.

Among these fluorine-containing surfactants, fluorine-containing quaternary ammonium salts having the following formula (1) are preferably used because the resultant toner can maintain good charge property even when environmental conditions are changed. 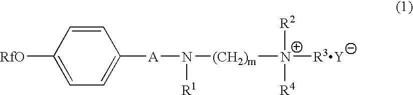
wherein Rf represents a perfluoroalkyl group; R1 represents a hydrogen atom, a fluorine atom or a hydrocarbon group; each of R2 to R4 represents a hydrogen atom, a fluorine atom or a hydrocarbon group; A represents a divalent organic group; Y represents a counter ion; and m is an integer not less than 1.

In formula (1), Rf represents a perfluoroalkyl group. Among perfluoroalkyl groups, perfluoroalkyl groups having from 3 to 30 carbon atoms, and preferably from 3 to 15 carbon atoms, are preferable. Suitable per fluoroalkyl groups include C₃ₙF₆ₙ₋₁ wherein n is an integer of from 1 to 20 and preferably from 1 to 10. Specific examples thereof include CF₃(CF₂)₅—, CF₃ (CF₂)₆—, CF₃(CF₂)₇—, CF₃(CF₂)₈—, CF₃(CF₂)₉—, CF₃(CF₂)₁₀—, CF₃(CF₂)₁₁—, CF₃(CF₂)₁₂—, CF₃(CF₂)₁₃—, CF₃(CF₂)₁₄—, CF₃(CF₂)₁₅—, CF₃(CF₂)₁₆—, CF₃(CF₂)₁₇—, (CF₃)₂CF(CF₂)₆—, etc.

In formula (1), Y represents a counter ion. Specific examples of the counter ions include halogen ions, a sulfate ion, a nitrate ion, a phosphate ion, a thiocyanate ion, organic acid ions, etc. Among these ions, halogen ions such as a fluorine ion, a chlorine ion, a bromine ion and an iodine ion are preferable.

In formula (1), A represents a divalent organic ion such as —SO₂—, —CO—, —(CH₂)ₓ—, —SO₂N(R⁵)—(CH₂)ₓ—, —(CH₂)ₓ—CH(OH)—(CH₂)ₓ—, etc., wherein x represents an integer of from 1 to 6, and R⁵ represents an alkyl group having 1 to 10 carbon atoms. Among these groups, —SO₂—, —CO—, —(CH₂)₂—, —SO₂N(C₂H₅)—(CH₂)₂—, or —CH₂CH(OH)(CH₂)— is preferable.

In formula (1), m is an integer not less than 1, preferably from 1 to 20, and more preferably from 1 to 10.

In formula (1), R¹ represents a hydrogen atom, a fluorine atom, or a hydrocarbon group, and each of R², R³ and R⁴ represents a hydrogen atom, a fluorine atom, or a hydrocarbon group. Suitable hydrocarbon groups include alkyl groups, alkenyl groups, and aryl groups, which can be substituted with one or more substituents.

Specific examples of the alkyl groups include alkyl groups having 1 to 10 carbon atoms such as methyl, ethyl, n-propyl, isopropyl, n-butyl, iso-butyl, sec-butyl, n-hexyl, iso-hexyl, n-heptyl, n-octyl, iso-octyl, n-decyl, and isodecyl groups. These groups can be substituted with one or more substituents.

Specific examples of the alkenyl groups include alkenyl groups having 1 to 10 carbon atoms such as vinyl, aryl, propenyl, isopropenyl, butenyl, hexenyl, and octenyl groups. These groups can be substituted with one or more substituents.

Specific examples of the aryl groups include aryl groups having 6 to 24 carbon atoms such as phenyl, tolyl, xylyl, cumenyl, styryl, mesityl, cinnamyl, phenetyl, and benzhydryl groups.

Among the compounds having formula (1), compounds having the following formula are preferable. 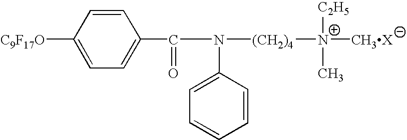
wherein X represents a halogen atom.

Specific examples of the compounds having formula (1) described above include compounds having one of the below-mentioned formulae (2) to (55). These compounds have a white color or a pale yellow color.

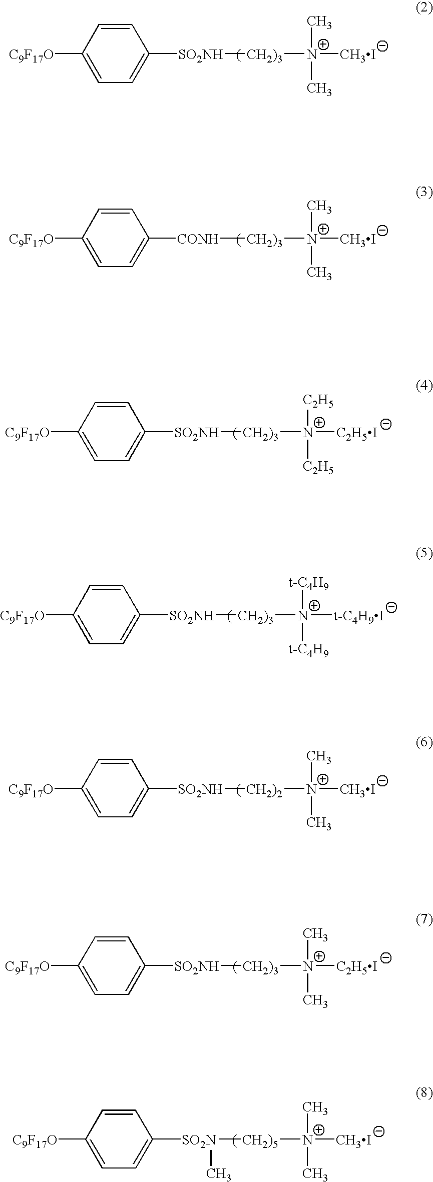

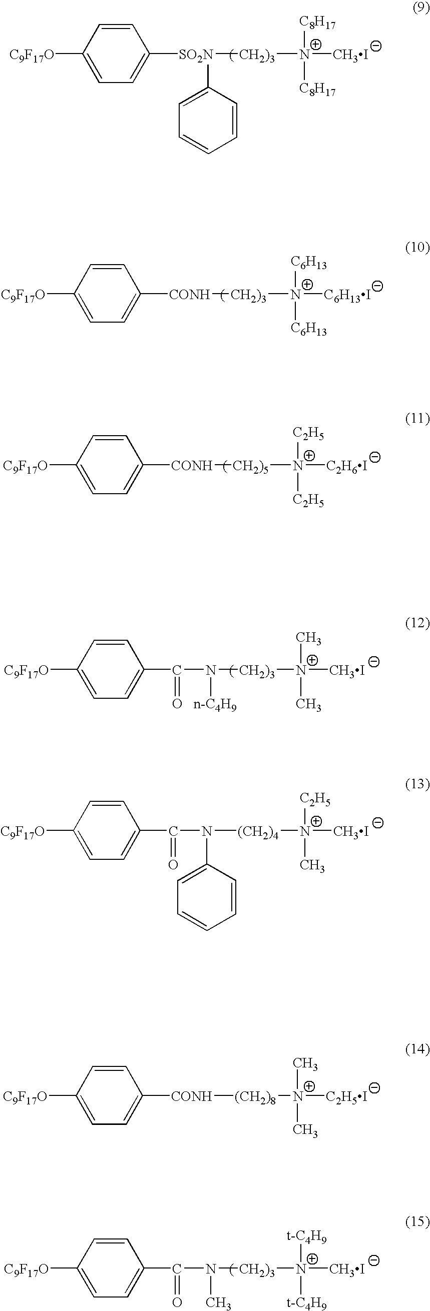

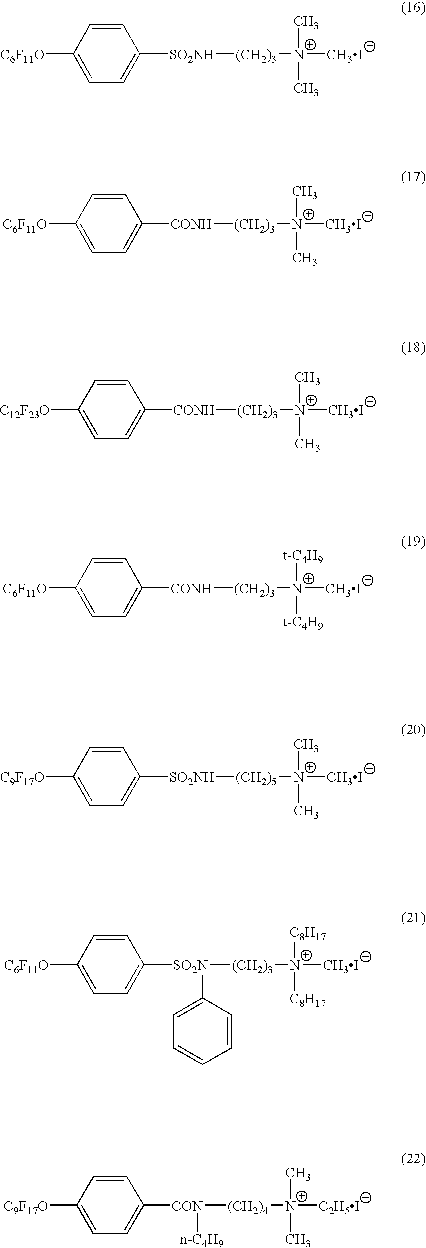

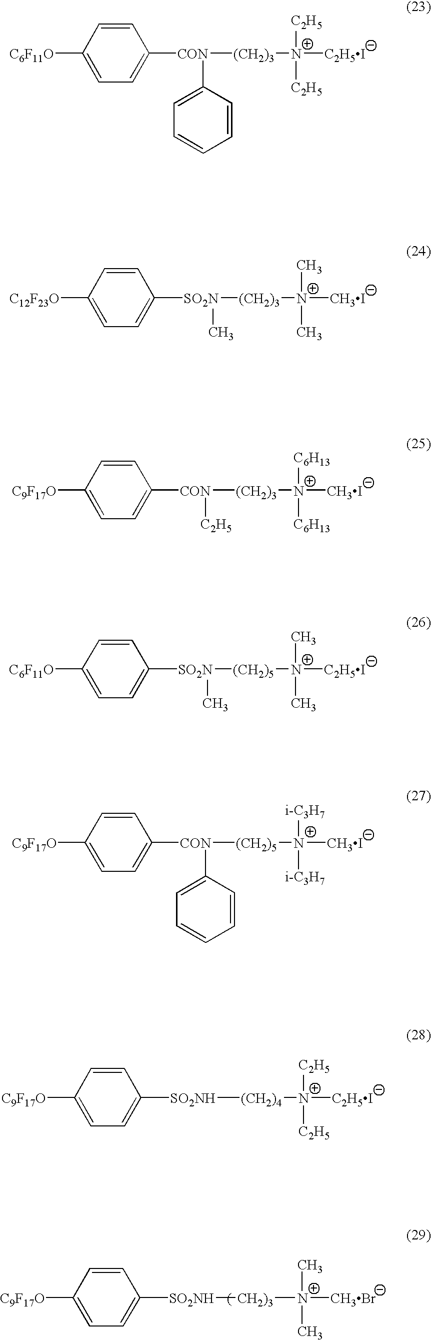

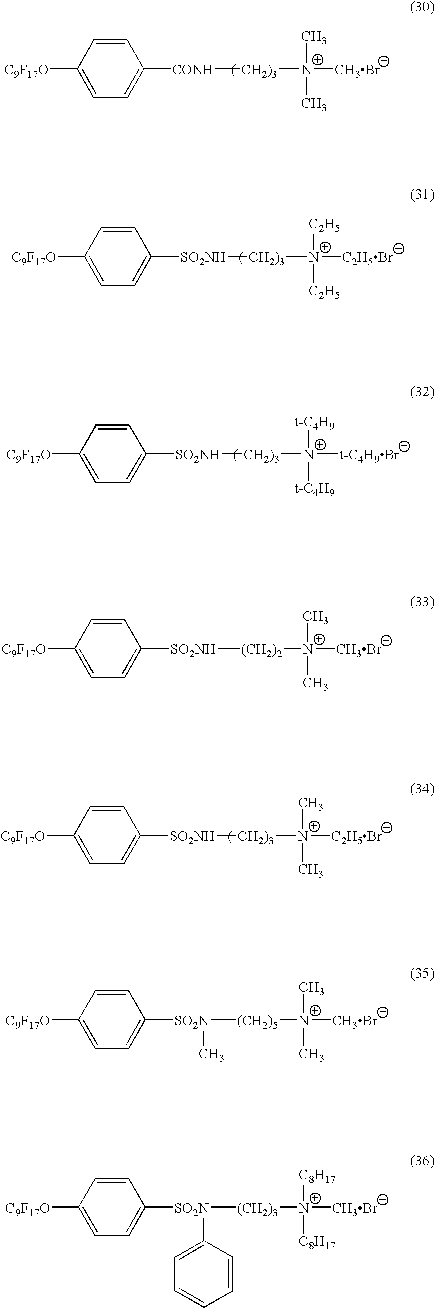

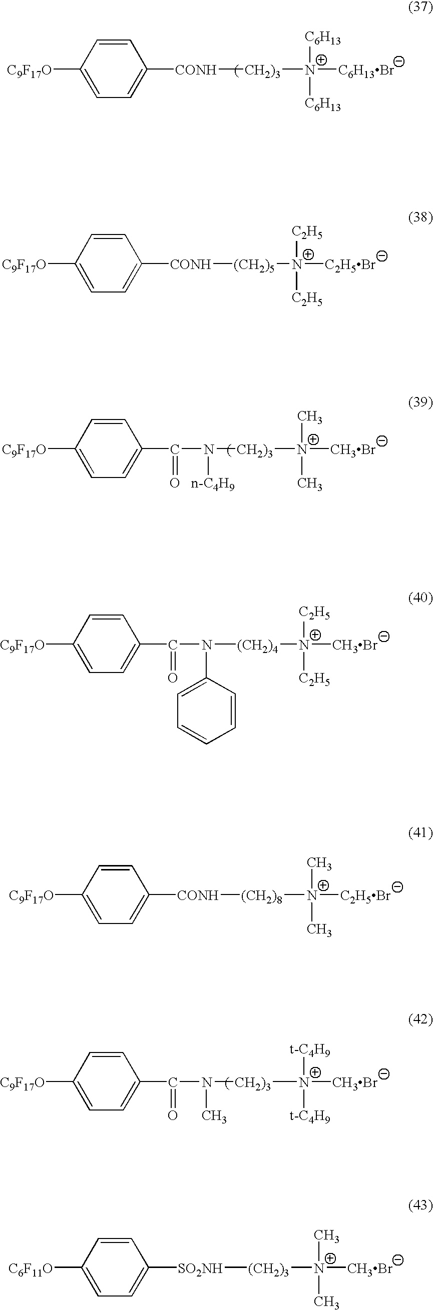

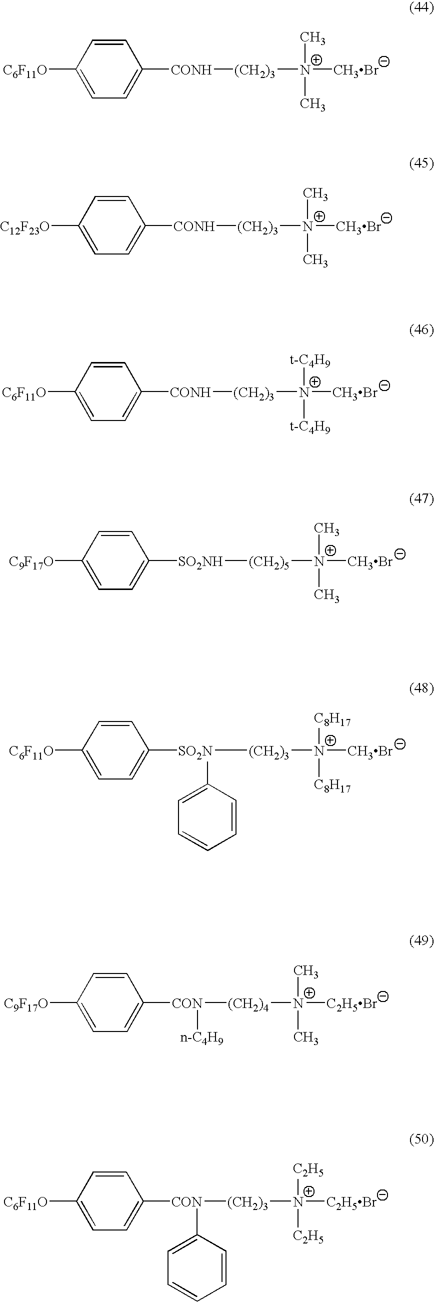

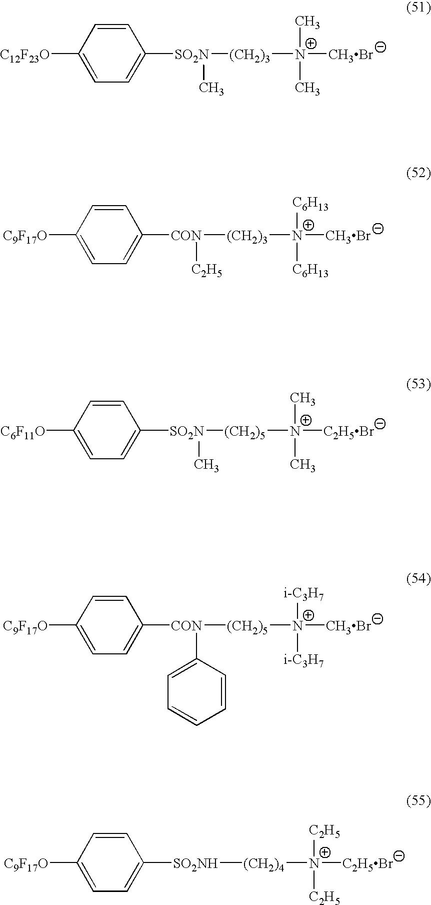

In addition to the surfactants having formulae (2) to (55), surfactants in which the halogen ions such as an iodine ion and a bromine ion in formulae (2) to (55) are replaced with a halogen ion such as a chlorine ion and a fluorine ion can also be used.

In the wet external addition process, a charge controlling agent and/or a particulate resin can be added to the aqueous dispersion in which the particulate material is dispersed, to impart good charge property to the toner particles. Specific examples of the charge controlling agent and particulate resin are compounds and resins mentioned above. The particulate diameter of the charge controlling agents used in this case is preferably from 0.01 to 1 μm. The content of the charge controlling agent and particulate resin in the aqueous dispersion is preferably from 0.01 to 5% by weight based on the weight of the toner particles.

The thus prepared toner particles can be used as they are. Alternatively, the toner particles are mixed with one or more other particulate materials such as the coloring agents, release agents, and charge controlling agents, which are mentioned above, optionally upon application of mechanical impact thereto to fix the particulate materials on the surface of the toner particles.

Specific examples of such mechanical impact application methods include methods in which a mixture is mixed with a highly rotated blade and methods in which a mixture is put into a jet air so that the particles collide against each other or a collision plate.

Specific examples of such mechanical impact applicators include ONG MILL (manufactured by Hosokawa Micron Co., Ltd.), modified I TYPE MILL in which the pressure of air used for pulverizing is reduced (manufactured by Nippon Pneumatic Mfg. Co., Ltd.), HYBRIDIZATION SYSTEM (manufactured by Nara Machine Co., Ltd.), KRYPTRON SYSTEM (manufactured by Kawasaki Heavy Industries, Ltd.), automatic mortars, etc.

By using the toner manufacturing method of the present invention, the toner of the present invention can be efficiently produced.

Developer

The developer of the present invention includes at least the toner of the present invention, and optionally includes a carrier and other components. The developer of the present invention can be a one component developer or a two component developer. When the developer is used for high speed image forming apparatus, two component developers are preferably used because of having a long life.

When the toner of the present invention is used as a one component developer, the developer has the following advantages.
(1) even when the developer is used for a long time while the developer (i.e., toner) is replenished, the particle diameter distribution of the developer hardly changes; and
(2) even when the developer is used (agitated) for a long time, the developer does not cause a problem in that the developer is adhered and fixed to the developing roller and the developer layer forming blade used.

Therefore images having good image qualities can be stably produced.

When the toner of the present invention is used for the two component developer, the developer has the following advantages.
(1) even when the developer is used for a long time while the toner is replenished, the particle diameter distribution of the toner hardly changes; and
(2) even when the developer is agitated in the developing device, the developer can maintain good developing ability.

Therefore images having good image qualities can be stably produced.

The carrier for use in the two component developer of the present invention is not particularly limited, and one or more proper carriers are chosen so that the resultant developer fits the needs. However, it is preferable to use a carrier which includes a core material coated with a resin.

Suitable materials for use as the core material include manganese-strontium materials and manganese-magnesium materials, which have a saturation magnetization of from 50 to 90 Am²/kg (50 to 90 emu/g). In view of image density, high magnetization materials such as iron powders (having a a saturation magnetization not less than 100 Am²/kg (100 emu/g) and magnetite having a saturation magnetization of from 75 to 120 Am²/kg (75 to 120 emu/g) are preferably used. In addition, low magnetization materials such as copper-zinc materials having a saturation magnetization of from 30 to 80 Am²/kg (30 to 80 emu/g) can be preferably used because the impact of the magnetic brush against the photoreceptor is relatively weak and high quality images can be produced.

These carrier materials can be used alone or in combination.

The core material of the carrier preferably has a volume average particle diameter (D₅₀) of from 10 to 150 μm, and more preferably from 40 to 100 μm. When the volume average particle diameter is too small (i.e. the content of fine carrier particles increases), the magnetization per each particle decreases, resulting in occurrence of a carrier scattering problem. When the particle diameter is too large, the surface area of the carrier per unit weight decreases and thereby a toner scattering problem tends to occur. In addition, another problem in that uneven solid images are formed tends to occur. This problem is remarkably caused when full color images are produced because full color images typically include large solid images.

Specific examples of such resins for use in coating the carriers include amino resins, vinyl or vinylidene resins, polystyrene resins, halogenated olefin resins, polyester resins, polycarbonate resins, polyethylene resins, polyvinyl fluoride resins, polyvinylidene fluoride resins, polytrifluoroethylene resins, polyhexafluoropropylene resins, vinylidenefluoride-acrylate copolymers, vinylidenefluoride-vinylfluoride copolymers, copolymers of tetrafluoroethylene, vinylidenefluoride and other monomers including no fluorine atom, silicone resins, epoxy resins, etc. These resins can be used alone or in combination.

Specific examples of the amino resins include urea-formaldehyde resins, melamine resins, benzoguanamine resins, urea resins, and polyamide resins. Specific examples of the vinyl or vinylidene resins include acrylic resins, polymethylmethacrylate resins, polyacrylonitirile resins, polyvinyl acetate resins, polyvinyl alcohol resins, polyvinyl butyral resins, etc. Specific examples of the polystyrene resins include polystyrene resins and styrene-acrylic copolymers. Specific examples of the halogenated olefin resins include polyvinyl chloride resins. Specific examples of the polyester resins include polyethyleneterephthalate resins and polybutyleneterephthalate resins.

If desired, an electroconductive powder can be included in the resin layer of the carrier. Specific examples of such electroconductive powders include metal powders, carbon blacks, titanium oxide, tin oxide, and zinc oxide. The average particle diameter of such electroconductive powders is preferably not greater than 1 μm. When the particle diameter is too large, it is hard to control the resistance of the coating layer.

The resin layer can be formed by coating a resin solution which is prepared by dissolving a resin in a solvent on a core material using any known coating method, followed by drying and baking. Suitable coating methods include dip coating methods, spray coating methods, brush coating methods, etc.

Specific examples of the solvent include toluene, xylene, methyl ethyl ketone, methyl isobutyl ketone, cellosolve butyl acetate, etc.

The method of baking the coated layer is not particularly limited, and external heating methods and internal heating methods can be used. For example, methods using a heating device such as fixed electric furnaces, fluid electric furnaces, rotary electric furnaces, and burner furnaces, and methods using microwave, are preferably used.

The coated amount of the resin is preferably 0.01 to 5.0% by weight based on the weight of the carrier. When the coated amount is too small, a uniform resin layer cannot be formed. When the coated amount is too large, the carrier particles aggregates, and thereby the toner cannot be uniformly charged.

The weight ratio of the toner to the carrier in the two component developer is from 1/99 to 10/90, and preferably from 3/97 to 7/93.

By using the developer of the present invention, high quality images having good fixing property can be stably produced.

The developer of the present invention can be used for known dry developing methods such as magnetic one component developing methods, nonmagnetic one component developing methods, two component developing methods, etc.

Toner Container

The toner container of the present invention contains the toner of the present invention. The container is not particularly limited with respect to shape, size, constitutional materials, etc., and a proper container is used depending on the image forming apparatus for which the toner is used.

The shape of the toner container is not particularly limited, and cylindrical containers, etc. can be used. The containers can have a spiral groove to smoothly discharge the toner therein when rotated. Containers with a groove, entire or part of which can be folded like accordion, can be preferably used.

Suitable materials for use as the toner container include resins having good dimension stability. Specific examples thereof include polyester resins, polyethylene resins, polypropylene resins, polystyrene resins, polyvinyl chloride resins, acrylic resins, polycarbonate resins, ABS resins, polyacetal resins, etc.

By using the toner container of the present invention, the toner of the present invention is easy to handle, store, and transport. The toner container of the present invention can be used by being detachably set in the process cartridge or image forming apparatus of the present invention mentioned below.

Image Forming Apparatus and Image Forming Method

Then the image forming apparatus and image forming method will be explained in detail referring to drawings.

The image forming apparatus of the present invention includes at least an image bearing member, an electrostatic latent image forming device, a developing device, a transferring device, and a fixing device, and optionally includes a discharger (a quencher), a cleaner, a toner recycling device, a controller and other devices.

The image forming method of the present invention includes at least an electrostatic latent image forming step, a developing step, an image transferring step, and a fixing step, and optionally includes a discharging step, a cleaning step, and a toner recycling step.

Then each of the devices and steps will be explained.

(1) Latent Image Forming Process and Image Bearing Member

In the latent image forming process, an electrostatic latent image is formed on an image bearing member.

The image bearing member (hereinafter sometimes referred to as a photoconductive insulator or photoreceptor) for use in the image forming apparatus of the present invention is not particularly limited with respect to the constitution materials, shape, size, etc. Namely, known image bearing members can be used. Among the image forming members, drum-form photoreceptors including a photosensitive material such as inorganic photosensitive materials (e.g., amorphous silicon and selenium) and organic photosensitive materials (e.g., polysilane, phthalopolymethine, organic photoconductors, combinations of charge generation materials and charge transporting materials, etc.) are preferably used. Among these photosensitive materials, amorphous silicon is preferably used because of having long life.

The coefficient of static friction of the surface of the photoreceptor is preferably from 0.1 to 0.4, and more preferably from 0.1 to 0.3. When the static friction coefficient is too low, a problem in that the toner images formed on the photoreceptor tend to be distorted occurs during the developing process because the toner images are slid on the surface of the photoreceptor by the developer layer formed on the developer bearing member. In contrast, when the static friction coefficient is too large, a cleaning problem in that toner particles remaining on the surface of the photoreceptor cannot be removed occurs because the toner particles are easily rotated by the cleaner (such as cleaning blades) used.

In the present invention, the static friction coefficient of the surface of the photoreceptor is measured by an Euler belt method. The Euler belt method is explained above.

In order to control the static friction coefficient of the surface of the photoreceptor so as to fall in the above-mentioned range, for example, the following methods can be used.
1) a friction coefficient decreasing material (such as lubricants) is included in the outermost layer of the photoreceptor; and
2) a lubricant is coated on the surface of the photoreceptor.

Suitable lubricants for use in decreasing the static friction coefficient of the surface of the photoreceptor include fluorine-containing resins, silicone resins, derivatives thereof, etc. These materials can be used alone or in combination.

Specific examples of the lubricants include homopolymers or copolymers of tetrafluoroethylene, trifluorochloroethylene, hexafluoropropylene, vinyl fluoride, vinylidene fluoride, and difluorodichloroethylene, silicone resins, waxes, etc.

When a lubricant is included in the uppermost layer of the photoreceptor, the content of the lubricant is preferably from 0.5 to 30% by weight. When the content is too low, the static friction does not fall in the above-mentioned preferable range. In contrast, when the content is too high, the mechanical strength of the uppermost layer deteriorates.

Suitable materials for use as the lubricant include fatty acid metal salts, fatty acid amides, fluorine-containing resins, waxes, etc.

Specific examples of the fatty acid metal salts include zinc stearate, barium stearate, iron stearate, nickel stearate, cobalt stearate, copper stearate, strontium stearate, calcium stearate, zinc oleate, barium oleate, lead oleate, zinc palmitate, barium palmitate, lead palmitate.

Specific examples of the fatty acid amides include saturated fatty acid mono-amides such as lauric acid amide, palmitic acid amide, stearic acid amide, behenic acid amide and hydroxystearic acid amide; unsaturated fatty acid mono-amides such as oleic acid amide, erucic acid amide and recinoleic acid amide; substituted amides such as N-stearylstearic acid amide, N-oleyloleic acid amide, N-stearyloleic acid amide, N-oleylstearic acid amide, N-stearylerucic acid amide, N-oleylpalmitic acid amide, methylolstearic acid amide and methylolbehenic acid amide; saturated fatty acid bisamides such as methylenebisstearic acid amide, ethylenebiscapric acid amide, ethylenebislauric acid amide, ethylenebisstearic acid amide, ethylenebisisostearic acid amide, ethylenebishydroxystearic acid amide, ethylenebisbehenic acid amide, hexamethylenebishydroxystearic acid amide, N,N′-distearyladipic acid amide and N,N′-distearylsebacic acid amide; unsaturated fatty acid amides such as ethylenebisoleic acid amide, hexamethylenebisoleic acid amide, N,N′-dioleyladipic acid amide and N,N′-dioleylsebacic acid amide; aromaic bisamides such as m-xylylenebisstearic acid amide and N,N′-distearylisophthalic acid amide; etc.

Specific examples of the fluorine-containing resins include polytetrafluoroethylene, polyvinylidene fluoride, etc.

Specific examples of the waxes include candelilla waxes, carnauba waxes, rice waxes, Japan waxes, jojoba oils, bees waxes, lanolin, etc.

When an uppermost layer including a lubricant is formed, the lubricant is preferably dissolved or dispersed in a solvent. Specific examples of such solvents include water, alcohols (e.g., methyl alcohol, ethyl alcohol, propyl alcohol, isopropyl alcohol, butyl alcohol, isobutyl alcohol and tert-butyl alcohol), ethyl acetate, methyl ethyl ketone, methyl isobutyl ketone, etc.

The method for coating the coating liquid is not particularly limited, and any known coating methods can be used. Specific examples of the coating methods include spray coating methods, spin coating methods, dip coating methods, kneader coating methods, curtain coating methods, blade coating methods, etc.

Then one example of the method of preparing the photoreceptor will be explained.

At first, an undercoat layer is formed on an aluminum drum by coating an undercoat layer coating liquid, which includes an alkyd resin (BEKKOZOl 1307-60-EL from Dainippon Ink & Chemicals, Inc.), a melamine resin (SUPER BEKKAMIN G-821-60 from Dainippon Ink & Chemicals, Inc.), titanium oxide (CR-EL from Ishihara Sangyo Kaisha Ltd.) and methyl ethyl ketone, and then drying the coated liquid.

Then a charge generation layer is formed on the undercoat layer by coating a charge generation layer coating liquid including a bisazo pigment having the below-mentioned formula (manufactured by Ricoh Co., ltd.), a polyvinyl butyral resin (XYHL from Union Carbide Corp.), cyclohexanone, and methyl ethyl ketone, and then drying the coated liquid.

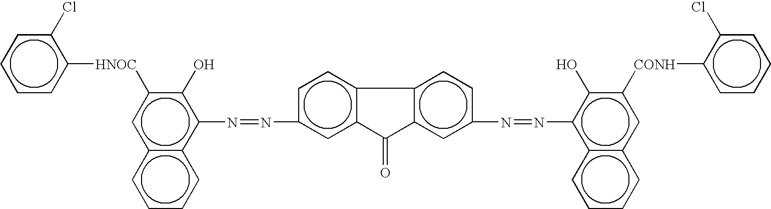

Further, a charge transport layer is formed on the charge generation layer by coating a charge transport layer coating liquid including a polycarbonate resin (Z-form polycarbonate resin from Teijin Chemicals Ltd. having a viscosity average molecular weight of 50,000), a low molecular weight charge transport material having the below-mentioned formula, tetrahydrofuran (THF) and a 1% tetrahydrofuran solution of a silicone oil (KF-50-100C from Shin-Etsu Chemical Co., Ltd.), and then drying the coated liquid.

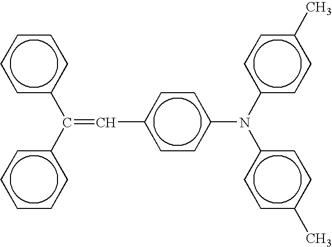

Furthermore, a protective layer is formed on the charge transport layer by coating a protective layer coating liquid, which is prepared by dispersing a polytetrafluoroethylene powder (LUBRON L-2 from Daikin Co., Ltd.), MODIPER F210 (fluorine-containing block copolymer, from NOF Corp.), a polycarbonate resin (Z-form polycarbonate resin from Teijin Chemicals Ltd. having a viscosity average molecular weight of 50,000) and tetrahydrofuran for 2 hours using a vibration mill including zirconia balls, by a spray coating method, and then drying the coated liquid.

Thus, a photoreceptor is prepared.

In the electrostatic latent image forming process, an electrostatic latent image is formed by uniformly charging the entire surface of the thus prepared photoreceptor using a charger, and irradiating the charged photoreceptor with imagewise light using an light irradiator.

Charging is performed by applying a voltage to the photoreceptor using a charger. Known chargers can be used for charging the photoreceptor. For example, contact chargers having a semi-conductive charging element such as rollers, brushes, films and rubber blades; and non-contact chargers such as corotrons and scorotrons can be used.

Image irradiation is performed by irradiating the charged photoreceptor with imagewise light using a light irradiating device. Known light irradiators can be used and a proper light irradiator is chosen and used for the image forming apparatus for which the toner of the present invention is used. Specific examples thereof include optical systems for use in reading images in copiers; optical systems using rod lens arrays; optical systems using laser; and optical systems using a liquid crystal shutter.

It is possible to irradiate the photoreceptor from the backside of the photoreceptor.

(2) Developing Process and Developing Device

In the developing process, the electrostatic latent image formed on the photoreceptor is developed with the abovementioned toner (or the developer) of the present invention to visualize the electrostatic latent image using a developing device.

Known developing devices can be used for the image forming apparatus of the present invention as long as the toner (or the developer) of the present invention can be used therefor. For example, developing devices containing the toner or developer therein and having a developing element which supplies the toner to the photoreceptor while contacting or non-contacting the photoreceptor can be used. The developing device preferably has the toner container mentioned above.

The developing device is a dry developing device which includes one or more developing sections for developing monochrome images or multi-color images. The developing device includes an agitator configured to agitate the toner or developer to charge the toner, and a developer bearing member (such as rotatable magnet rollers) bearing the toner or developer to supply the toner to the photoreceptor.

In the developing device, the toner and a carrier are agitated so that the toner is charged. The toner and carrier are then fed to the developer bearing member and form a magnetic brush on the surface of the developer bearing member. Since the developer bearing member is located closely to the photoreceptor, the toner contained in the magnetic brush is electrostatically attracted by the electrostatic latent image, resulting in transferring of the toner to the latent image. Thus, the latent image is developed with the toner, resulting in formation of a toner image on the surface of the photoreceptor.

The developer contained in the developing device may be a one-component developer which includes the toner of the present invention and does not include a carrier, or a two-component developer which includes the toner of the present invention and a carrier (i.e., the two-component developer of the present invention).

(3) Transferring Process and Transfer Device

In the transferring process, it is preferable that the toner image formed above is at first transferred to an intermediate transfer medium (first transfer process), and the toner image is then transferred to a receiving material (second transfer process). When multiple color images and full color images are formed using two or more color toners, it is preferable that plural color toner images are transferred to an intermediate transfer medium one by one (first transfer process), and the plural toner images on the intermediate transfer medium are transferred to a receiving material at the same time (second transfer process).

It is preferable that toner images on the image bearing member are transferred while applying a voltage to the image bearing member and/or the transferring element. When an intermediate transfer medium is used, the transferring device preferably includes a first transferring member configured to transfer the toner image on the photoreceptor to the intermediate transfer medium and a second transferring member configured to transfer the toner image on the intermediate transfer medium to a receiving material.

The intermediate transfer medium for use in the image forming apparatus of the present invention is not particularly limited with respect to shape, materials, etc., and any known intermediate transfer media can be used. Specific examples thereof include belt-form intermediate transfer media.

The transfer device (the above-mentioned first and second transferring members) preferably include a transferrer, which can easily transfer the toner images to a receiving material, such as corona discharging transferrers, transfer belts, transfer rollers, pressure transfer rollers, adhesive transferrers.

The receiving material is not particularly limited with respect to constitutional materials, size, physical properties, etc., and known receiving materials can be used.

(4) Fixing Process and Fixing Device

In the fixing process, the toner image transferred to a Receiving material is fixed thereto using a fixing device. When plural toner images are transferred, the fixing operation can be performed on each toner image whenever the toner image is transferred on the receiving material, or on all the toner images at the same time after all the toner images are transferred on the receiving material.

The fixing device is not particularly limited, and a proper fixing device is chosen and used for the image forming apparatus for which the toner of the present invention is used. Suitable fixing devices include heat fixing devices which heat toner images while applying a pressure thereto. Specific examples thereof include combinations of a heat roller and a pressure roller, and combinations of a heat roller, a pressure roller and an endless belt.

When a heat fixing device is used, the fixing temperature is preferably from 80 to 200° C.

It is possible to use a fixing device which fixes toner images using light and a combination of the light fixing device and a heat fixing device.

(5) Cleaning Process and Cleaning Device

In the cleaning process, particles of the toner, which remain on the surface of the photoreceptor even after the toner image thereon is transferred on a receiving material, are removed therefrom using a cleaning device.

Known cleaners can be used for the cleaning device. Specific examples thereof include magnetic brush cleaners, electrostatic brush cleaners, magnetic roller cleaners, blade cleaners, brush cleaners, and web cleaners.

(6) Discharging (Quenching) Process and Discharging Device

In the discharging process, charges remaining on the photoreceptor even after the toner image thereon is transferred from the photoreceptor to a receiving material are discharged by applying a discharging bias to the photoreceptor or irradiating the photoreceptor with light, using a discharging device.

Known discharging device scan be used. Specific examples thereof include discharging (quenching) lamps.

(7) Toner Recycling Process and Recycling Device

In the toner recycling process, particles of the toner collected by the cleaners are returned to the developing device using a recycling device to be reused for developing electrostatic latent images.

Known powder feeding devices can be used as the recycling device.

(8) Controlling Process and Controller

The above-mentioned processes (devices) are controlled by a controller. The controller is not particularly limited, and known controllers such as sequencers and computers can be used.

The image forming processes and image forming apparatus of the present invention will be explained in detail referring to drawings.

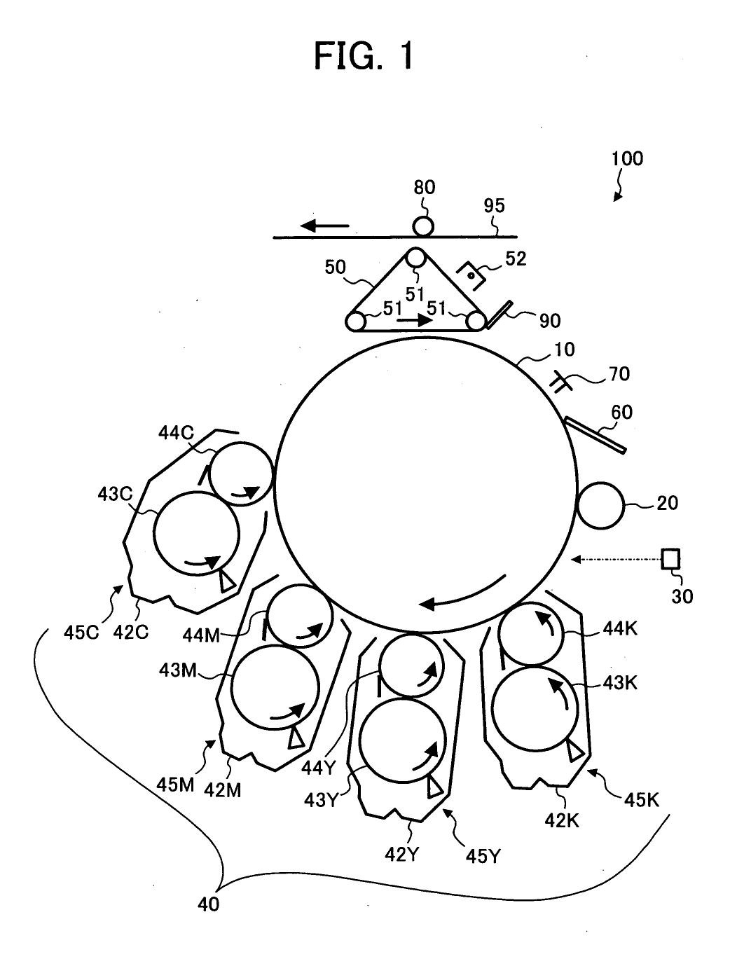

FIG. 1 is a schematic view illustrating an embodiment of the image forming apparatus of the present invention.

In FIG. 1, an image forming apparatus 100 includes a photoreceptor drum 10 (hereinafter referred to as a photoreceptor 10) serving as the image bearing member; a charging roller 20 serving as the charging device; a light irradiator 30 serving as the latent image forming device; a developing device 40 serving as the image developing device; an intermediate transfer medium 50; a cleaner 60 serving as the cleaning device and including a cleaning blade; and a discharging lamp 70 serving as the discharging device.

The intermediate transfer medium 50 is an endless belt which is rotated in a direction indicated by an arrow by three rollers 51 arranged therein while tightly stretched by the rollers. At least one of the three rollers 51 applies a transfer bias (first transfer bias) to the intermediate transfer medium 50. A cleaner 90 is provided to clean the surface of the intermediate transfer medium 50.

On the upper side of the intermediate transfer medium 50, a transfer roller 80 is provided which applies a transfer bias (a second transfer bias) to a receiving material 95 on which a toner image is to be transferred. In addition, a corona charger 52 is provided to charge the toner image on the intermediate transfer medium 50 before the toner image is transferred to the receiving material 95.

A developing device 40 includes a black developing unit 45K; a yellow developing unit 45Y; a magenta developing unit 45M; and a cyan developing unit 45C. Each of the developing units includes a developer containing portion 42 (42K, 42Y, 42M or 42C), a developer supplying roller 43 (43K, 43Y, 43M or 43C), and a developing roller 44 (44K, 44Y, 44M or 44C).

In the image forming apparatus 100, the surface of the photoreceptor 10 is uniformly charged with the charging roller 20. The light irradiator 30 irradiates the charged surface of the photoreceptor 10 with imagewise light to form an electrostatic latent image on the photoreceptor 10. The developing device 40 develops the latent image with color toners, each of which is the toner of the present invention, to sequentially form color toner images on the photoreceptor 10. The color toner images are transferred to the intermediate transfer medium 50 (first transfer) to form a toner image (e.g., a full color toner image) thereon while at least one of the rollers 51 applies a transfer bias thereto. The toner image formed on the intermediate transfer medium 50 is then transferred to the receiving material 95 (second transfer). Particles of the toner remaining on the photoreceptor 10 are removed with the cleaner 60 and charges remaining on the photoreceptor 10 are removed by irradiating the photoreceptor 10 with light using the discharging lamp 70.

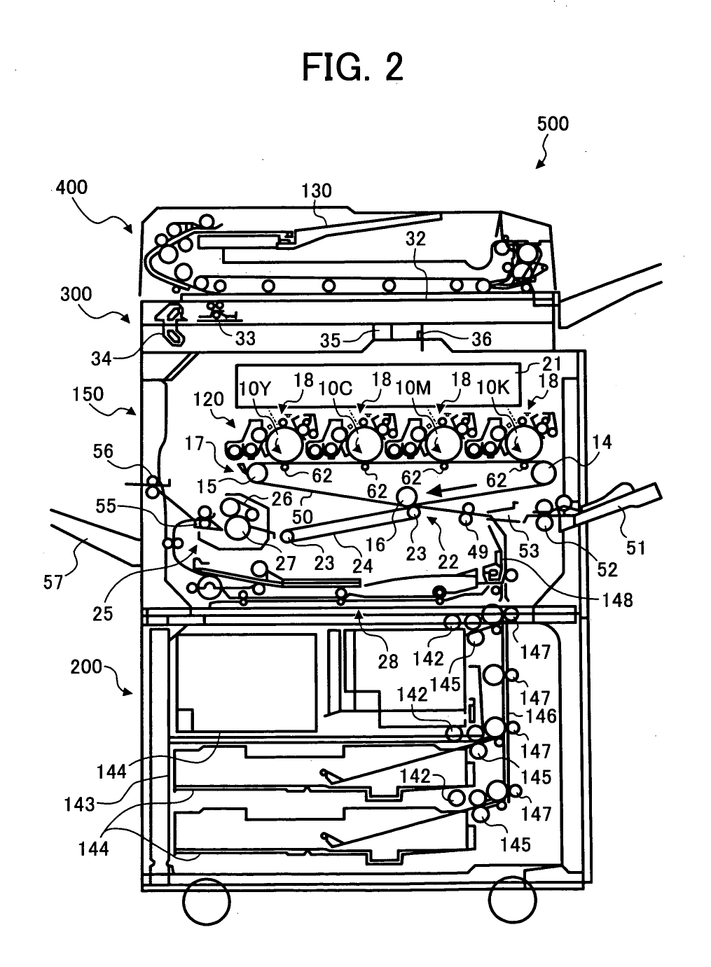

The image forming operations will be explained referring to FIG. 2.

FIG. 2 is the overview of an embodiment of the image forming apparatus of the present invention, which is a tandem-type color image forming apparatus.

In FIG. 2, a tandem-type color image forming apparatus 500 includes an image forming section 150, a paper feeding section 200, a scanner 300 and an automatic document feeder 400.

The image forming section 150 includes an endless intermediate transfer medium 50 which is provided in the center of the image forming section 150. The intermediate transfer medium 50 is rotated in the clockwise direction by rollers 14, 15 and 16 while tightly stretched by the rollers. A cleaner 17 is provided near the roller 15 to remove particles of the toner remaining on the surface of the intermediate transfer medium.

Four image forming units 18 for forming yellow, magenta, cyan and black toner images are arranged side by side on the intermediate transfer medium 50. The image forming units 18 include respective photoreceptors 10Y, 10M, 10C and 10K. Numeral 120 denotes a tandem type developing device. The developing device 120 includes four developing devices arranged in the respective four image forming units 18. A light irradiator 21 is arranged at a location over the image forming units 18.

A second transfer device 22 is provided below the intermediate transfer medium 50. The second transfer device 22 includes an endless belt 24 which is rotatably stretched a pair of rollers 23. The endless belt 24 feeds a receiving material so that the toner images on the intermediate transfer medium 50 are transferred to the receiving material while sandwiched by the intermediate transfer medium 50 and the endless belt 24.

A fixing device 25 is arranged at a position near the second transfer device 22. The fixing device 25 includes an endless fixing belt 26 and a pressure roller 27 which presses the fixing belt 26.

In addition, a sheet reversing device 28 configured to reverse the receiving material is provided at a position near the fixing device 25, to produce double-sided copies.

Then the full color image forming operation of the tandem-type color image forming apparatus 500 will be explained.

An original to be copied is set on an original table 130 of the automatic document feeder 400. Alternatively, the original is directly set on a glass plate 32 of the scanner 300 after the automatic document feeder 400 is opened, followed by closing of the automatic document feeder 400. When a start button (not shown) is pushed, the color image on the original on the glass plate 32 is scanned with a first traveler 33 and a second traveler 34 which move in the right direction. In the case where the original is set on the table 130 of the automatic document feeder 400, at first the original is fed to the glass plate 32, and then the color image thereon is scanned with the first and second travelers 33 and 34. The first traveler 33 irradiates the color image on the original with light and the second traveler 34 reflects the light reflected from the color image to send the color image light to a sensor 36 via a focusing lens 35. Thus, color image information (i.e., black, yellow, magenta and cyan color image data) is provided.

The black, yellow, magenta and cyan color image data are sent to the respective black, yellow, magenta and cyan color image forming units 18, and black, yellow, magenta and cyan color toner images are formed on the respective photoreceptors 10K, 10Y, 10M and 10C. The toner image forming operation is the same as that mentioned in the image forming apparatus illustrated in FIG. 1.

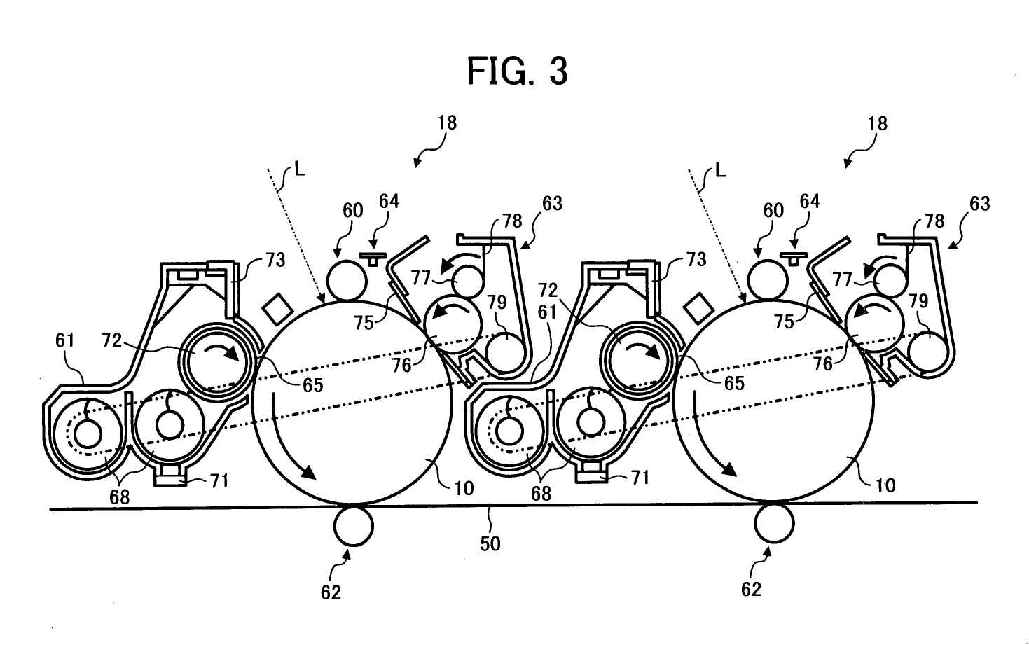

FIG. 3 is a schematic view illustrating a part of the image forming units 18.

Numeral 60, 61, 62, 63 and 64 denote a charger, a developing device, a transfer roller, a cleaner and a discharger.

The developing device 61 includes agitators 68, a developing roller 72, and a regulating blade 73 configured to form a developer layer 65 on the surface of the developing roller. Numeral 71 denotes a toner sensor configured to determine the toner concentration. Character L denotes imagewise light.

The cleaner 63 includes cleaning blade 75, a cleaning brush 76, a roller 77, a blade 78 and a toner recycling device 79 configured to feed the collected toner particles to the developing device 61.

Referring back to FIG. 2, the thus prepared black, yellow, magenta and cyan color toner images are transferred one by one to the intermediate transfer medium 50 which is rotated by the rollers 14, 15 and 16, resulting in formation of a full color toner image on the intermediate transfer medium 50. Numeral 62 denotes a transfer charger.

On the other hand, one of paper feeding rollers 142 is selectively rotated to feed the top paper sheet of paper sheets stacked in a paper cassette 144 in a paper bank 143 while the paper sheet is separated one by one by a separation roller 145 when plural paper sheets are continuously fed. The paper sheet is fed to a passage 148 in the image forming section 150 through a passage 146 in the paper feeding section 200, and is stopped once by a registration roller 49. Numeral 147 denotes feed rollers. A paper sheet can also be fed from a manual paper tray 51 to a passage 53 by a separation roller 52. The thus fed paper sheet is also stopped once by the registration roller 49. The registration roller 49 is generally grounded, but a bias can be applied thereto to remove paper dust therefrom.

The thus prepared full color toner image on the intermediate transfer medium 50 is transferred to the paper sheet, which is timely fed by the registration roller 49, at the contact point of the second transfer device 22 with the intermediate transfer medium 50. Particles of the toner remaining on the surface of the intermediate transfer medium 50 even after the second image transfer operation are removed therefrom by the cleaner 17.

The paper sheet having the full color toner image thereon is then fed by the second transfer device 22 to the fixing device 25, and the toner image is fixed on the paper sheet upon application of heat and pressure. Then the paper sheet is discharged from the image forming section 150 by a discharge roller 56 while the path is properly selected by a paper path changing pick 55. Thus, a copy is stacked on a tray 57. When a double sided copy is produced, the paper sheet having a toner image on one side thereof is fed to the sheet reversing device 28 to be reversed. Then the paper sheet is fed to the second transfer device 24 so that an image is transferred to the other side of the paper sheet. The image is also fixed by the fixing device 25 and then the copy is discharged to the tray 57 by the discharge roller 56.

Then the process cartridge of the present invention will be explained.

The process cartridge of the present invention includes at least an image bearing member (e.g., photoreceptor) and a developing device configured to develop an electrostatic latent image formed on the image bearing member with the toner of the present invention, and optionally includes one or more devices such as chargers and cleaners.

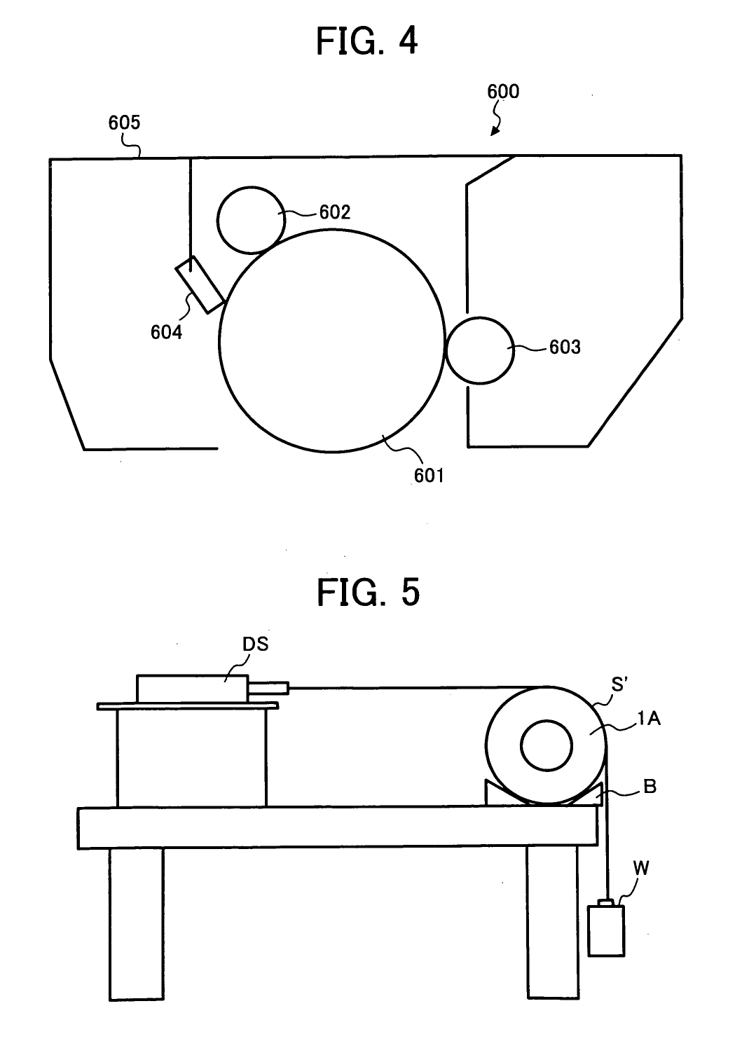

FIG. 4 is a schematic view illustrating an embodiment of the process cartridge of the present invention.

Numeral 600 denotes the process cartridge. The process cartridge 600 includes a photoreceptor 601, a charger 602, a developing device 603, a cleaner 604 and a housing 605.

The surface of the image bearing member has a static friction coefficient of from 0.1 to 0.4 and the toner is the toner of the present invention.

The process cartridge 600 can be detachably set in an image forming apparatus such as copiers and printers.

The image forming apparatus including such a process cartridge can perform image forming operations similar to those mentioned above (i.e., charging, irradiating, developing, transferring, fixing, cleaning, etc.).

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Example 1

Preparation of Toner Binder

The following components were contained in a reaction container having a condenser, a stirrer and a nitrogen introducing tube to perform a polycondensation reaction for 8 hours at 230° C. under normal pressure.

| | | |
|---|---|---|
| Adduct of bisphenol A with 2 mole of | 724 | parts |
| ethylene oxide | | |
| Terephthalic acid | 276 | parts |
| Dibutyl tin oxide | 2 | parts |

Then the reaction was further continued for 5 hours under a reduced pressure of from 10 to 15 mmHg. Thus, an unmodified polyester resin having a peak molecular weight of 4800 was prepared.

Then 10 parts of trimellitic anhydride were added to the unmodified polyester resin and the mixture was reacted at 200° C. for 2 hours under a reduced pressure of from 10 to 15 mmHg to replace the hydroxyl group present at the end portion of the unmodified polyester resin with a carboxyl group.

One hundred (100) parts of the thus prepared polyester resin were dissolved in 100 parts of ethyl acetate to prepare an ethyl acetate solution of the binder resin.

A part of the resin solution was dried to solidify the polyester resin. It was confirmed that the polyester resin have a glass transition temperature (Tg) of 62° C., an acid value of 32 mgKOH/g, a number average molecular weight (Mn) of 2,400 and a weight average molecular weight (Mw) of 5,200.

Preparation of Prepolymer

The following components were contained in a reaction container equipped with a condenser, a stirrer and a nitrogen introducing tube and reacted for 8 hours at 230° C. under normal pressure.

| | | |
|---|---|---|
| Adduct of bisphenol A with 2 mole of | 724 | parts |
| ethylene oxide | | |
| Isophthalic acid | 276 | parts |
| Dibutyl tin oxide | 2 | parts |

Then the reaction was further continued for 5 hours under a reduced pressure of from 10 to 15 mmHg, and then the reaction product was cooled to 160° C. Further, 32 parts of phthalic anhydride were added thereto to perform a reaction for 2 hours at 160° C.

After being cooled to 80° C., the reaction product was reacted with 188 parts of isophorone diisocyanate in ethyl acetate for 2 hours. Thus, a prepolymer having an isocyanate group (i.e., a group having an active hydrogen) was prepared.

It was confirmed that the thus prepared prepolymer include free isocyanate in an amount of 1.53% by weight.

Preparation of Ketimine Compound

In a reaction container equipped with a stirrer and a thermometer, 170 parts of isophorone diamine and 75 parts of methyl ethyl ketone were contained and reacted for 5 hours at 50° C. to prepare a ketimine compound. It was confirmed that the ketimine compound have an amine value of 418 mgKOH/g.

Preparation of Oil Phase Liquid

At first, 200 parts of an ethyl acetate solution of the unmodified polyester resin prepared above, 5 parts of a carnauba wax, and 4 parts of a copper phthalocyanine pigment were fed into a ball mill pot including zirconia balls having a diameter of 5 mm to be subjected to ball milling for 24 hours. Then the prepolymer prepared above was added thereto in such an amount that the solid of the prepolymer is 20 parts and the mixture was agitated. Thus, an oil phase liquid was prepared.

Emulsification and Dispersion

Sixty (60) parts of tricalcium phosphate and 3 parts of sodium dodecylbenzenesulfonate were dissolved and dispersed in 600 parts of ion-exchange water contained in a beaker. The mixture was agitated by a TK HOMOMIXER from Tokushu Kika Kogyo Co., Ltd. while the rotor of TK HOMOMIXER was rotated at a revolution of 14,000 rpm and the temperature of the mixture was maintained at 20° C. Thus, an aqueous phase liquid was prepared. Then a mixture of the oil phase liquid prepared above and 1 part of the above-prepared ketimine compound, which had been added to the oil phase liquid just before, was added to the aqueous phase liquid, and the mixture was agitated for 3 minutes to prepare an emulsion.

Then the emulsion was transferred to a flask equipped with an agitator and a thermometer and heated for 8 hours at 30° C. under a reduced pressure of 50 mmHg. Thus, the solvent (i.e., the ethyl acetate) was removed from the emulsion, resulting in preparation of a dispersion. It was confirmed by gas chromatography that the content of ethyl acetate in the dispersion is not higher than 100 ppm.

Washing

The thus prepared dispersion was cooled to room temperature, and 120 parts of a 35% concentrated hydrochloric acid were added thereto to dissolve the tricalcium phosphate in the dispersion. The mixture was then agitated for 1 hour at room temperature, followed by filtering.

The thus prepared cake was dispersed in distilled water to be washed, followed by filtering. This washing operation was performed three times. The thus prepared cake was dispersed again in distilled water so that the resultant dispersion has a solid content of 10% by weight. Thus, a toner particle dispersion was prepared.

Wet External Addition Process

Preparation of Particulate Silica Dispersion

Three (3) parts of a hydrophobized silica X-24 manufactured by Shin-Etsu Chemical Co., Ltd. were gradually added to a mixture of 0.2 parts of a fluorine-containing surfactant (FUTARGENT 310 from NEOS), 70 parts of ion-exchange water and 30 parts of methanol while agitating. Thus, a particulate silica dispersion was prepared.

Wet External Addition

The particulate silica dispersion was added to the toner particle dispersion prepared above. Then the mixture was agitated for 1 hour at room temperature. The mixture was subjected to filtering to prepare a wet cake. The wet cake was dried for 24 hours at 40° C. under a reduced pressure.

Thus, toner particles were prepared.

Evaluation Method

The thus prepared toner particles were evaluated as follows.

1. Particle Diameter of Toner (Dv, Dn, Dv/Dn)

The volume average particle diameter (Dv) and number average particle diameter (Dn) of the toner particles were measured using an instrument COULTER COUNTER TAII from Coulter Electronics, Inc. and an aperture of 100 μm. In addition, the ratio Dv/Dn was determined on calculation.

2. Average Circularity (AC)

The average circularity of the toner particles was determined as follows using a flow-type particle image analyzer FPIA-2100 from Sysmex Corp.:
(1) at first 100 to 150 ml of water from which solid foreign materials have been removed, 0.1 to 0.5 ml of a surfactant (alkylbenzenesulfonate) and 0.1 to 0.5 g of the toner particles were mixed to prepare a dispersion;
(2) the dispersion is further subjected to a supersonic dispersion treatment for 1 to 3 minutes using a machine manufactured by Honda Denshi Co., Ltd. to prepare a dispersion including particles of from 3,000 to 10,000 pieces/μl;
(3) the dispersion is passed through a detection area formed on a plate in the measuring instrument; and
(4) the particles are optically detected by a CCD camera and then the shapes thereof are analyzed with an image analyzer.

The circularity of a particle is determined by the following equation:
Circularity=Cs/Cp,
wherein Cp represents the length of the circumference of the projected image of a particle and Cs represents the length of the circumference of a circle having the same area as that of the projected image of the particle.
3. Observation of Toner Particles with SEM

The toner particles were observed and photographed using a scanning electron microscope. As a result, it was confirmed that a particulate silica having an average particle diameter of about 0.12 μm is uniformly adhered to the surface of the toner particles.

Dry External Addition Process

Then 1.2 parts of a hydrophobized silica (HDK H-2000 from Hoechst Japan), 0.5 parts of a hydrophobized titanium oxide (STT-30A from Titan Kogyo K.K.) and 0.1 parts of zinc stearate were mixed with 100 parts of the toner particle prepared above using a HENSCHEL mixer (manufactured by Mitsui Mining Co., Ltd.) under dry conditions. Thus, a cyan toner of Example 1 was prepared.

Preparation of Developer

The thus prepared cyan toner was mixed with a copper-zinc ferrite carrier, which had been coated with a silicone resin and which has an average particle diameter of 40 μm, in a mixing ratio of 5/95 (toner/carrier) by weight. The mixture was mixed for 10 minutes using a blender.

Thus, a developer of Example 1 was prepared.

Preparation of Image Bearing Member (i.e., Photoreceptor)

Preparation of Undercoat Layer

The following components were mixed to prepare an undercoat layer coating liquid.

| | | |
|---|---|---|
| Titanium oxide | 40 | parts |
| (CR-EL from Ishihara Sangyo Kaisha Ltd.) | | |
| Alkyd resin | 10 | parts |
| (BEKKOZOL 1307-60-EL from Dainippon Ink & | | |
| Chemicals, Inc.) | | |
| Melamine resin | 7 | parts |
| (SUPER BEKKAMIN G-821-60 from Dainippon Ink & | | |
| Chemicals, Inc., solid content of 60%) | | |
| Methyl ethyl ketone | 200 | parts |

The undercoat layer coating liquid was coated on a peripheral surface of an aluminum drum with a diameter of 30 mm, followed by drying. Thus, an undercoat layer having a thickness of 3.5 μm was prepared.

Preparation of Charge Generation Layer

The following components were mixed to prepare a charge generation layer coating liquid.

| | |
|---|---|
| Bisazo pigment having | 5 parts |
| the below-mentioned formula | |
| (manufactured by Ricoh Co., ltd.) | |

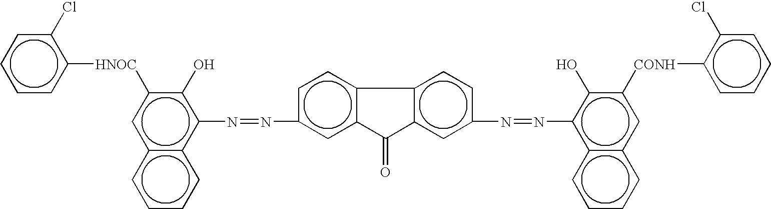

| | |
|---|---|
| Polyvinyl butyral resin | 1 part |
| (XYHL from Union Carbide Corp.) | |
| Cyclohexanone | 200 parts |
| Methyl ethyl ketone | 80 parts |

The thus prepared charge generation layer coating liquid was coated on the undercoat layer, followed by drying to prepare a charge generation layer having a thickness of 0.3 μm.

Preparation of Charge Transport Layer

The following components were mixed to prepare a charge transport layer coating liquid.

| | |
|---|---|
| Polycarbonate | 10 parts |
| (Z-form polycarbonate from Teijin Chemical Ltd., | |
| viscosity average molecular weight of 50,000) | |
| Charge transport material having | 7 parts |
| the following formula | |

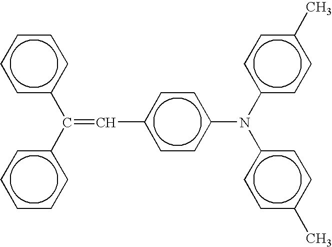

| | |
|---|---|
| Tetrahydrofuran | 100 parts |
| 1% tetrahydrofuran solution of silicone oil | 1 part |
| (silicone oil: KF-50-100C) | |

The charge transport layer coating liquid was coated on the charge generation layer, followed by drying to prepare a charge transport layer having a thickness of 22 μm.

Preparation of Protective Layer

The following components were mixed.

| | | |
|---|---|---|
| Polytetrafluoroethylene powder | 1 | part |
| (LUBRON L-2 from Daikin Industries, Ltd.) | | |
| Fluorine-containing block copolymer | 0.1 | parts |
| (MODIPER F210, NOF Corporation) | | |
| Polycarbonate | 9 | parts |
| (Z-form polycarbonate from Teijin Chemical Ltd., viscosity | | |
| average molecular weight of 50,000) | | |
| Tetrahydrofuran | 90 | parts |

The mixture was dispersed for 2 hours using a vibration mill including zirconia balls with a diameter of 2 mm. The thus prepared protective layer coating liquid was coated on the charge transport layer by a spray coating method, followed by drying, to prepare a protective layer having a thickness of 5 μm was prepared.

Thus, a photoreceptor of Example 1 was prepared.

The photoreceptor was evaluated as follows.

1. Static Friction Coefficient

The static friction coefficient of the surface of the photoreceptor was measured by an Euler belt method. The measurement conditions are as follows.
Paper: TYPE 6200 from Ricoh Co., Ltd. with a width of 30 mm and a length of 210 mm
   (longitudinal direction of the paper is parallel to the cross direction (the direction perpendicular to the machine direction) of the paper manufacturing machine)
Load: 100 g.
   2. Cleanability

The developer and photoreceptor prepared above were set in a color copier (IPSIO COLOR 8100 from Ricoh Co., Ltd.) and a running test in which 100,000 copies of an original image with an image area proportion of 7% are produced using TYPE 6000 paper (from Ricoh Co., Ltd.) was performed. Then ten copies of an original image with an image area proportion of 50% were continuously produced under a condition of 10° C. and 15% RH. When the tenth image was developed, the copier was suddenly stopped and particles of the toner present on a portion of the surface of the photoreceptor, which portion is located after the cleaner (i.e., the portion had been already cleaned with the cleaner), are transferred to an adhesive tape. Then the adhesive tape was visually observed to determine whether the tape is soiled with toner particles. The degree of soil is classified into the following four grades.
⊚: Excellent
◯: Good
Δ: Fair (acceptable)
X: Bad (undesired streak images were observed in the entire image).
   3. Image Density

The developer and photoreceptor prepared above were set in a color copier (IPSIO COLOR 8100 from Ricoh Co., Ltd.) and a running test in which 100,000 copies of an original image which includes solid images and which has an image area proportion of 5% are continuously produced using TYPE 6000<70W> paper (from Ricoh Co., Ltd.) was performed. The image densities of randomly selected five points of each of the first image, 10,000^{th} image and 100,000^{th} image ware measured with a spectro-densitometer 938 from X-Rite to determine the average image density of each image. In this regard, the higher the image density value, the denser the image.

4. Static Friction Coefficient After Running Test

The static friction coefficient of the surface of the photoreceptor was also measured in the same way as mentioned above after a running test in which 1,000,000 copies of an original image with an image area proportion of 7% are produced using TYPE 6000 paper (from Ricoh Co., Ltd.).

### Example 2

The procedure for preparation of the toner in Example 1 was repeated except that in the wet external addition process the mixture of the particulate silica dispersion and the toner particle dispersion was agitated for 1 hour at 50° C.

Thus, a toner of Example 2 was prepared. The toner was also evaluated in the same way as mentioned in Example 1. The results are shown in Tables 1 and 2.

The toner particles were observed and photographed using a scanning electron microscope. As a result, it was confirmed that a particulate silica having an average particle diameter of about 0.12 μm is uniformly adhered to the surface of the toner particles while slightly embedded to the toner particles.

### Comparative Example 1

The procedure for preparation of the toner in Example 1 was repeated except that the particulate silica dispersion used in the wet external addition process was replaced with the mixture of the following components (i.e., the silica is removed from the dispersion).

| | | |
|---|---|---|
| Fluorine-containing surfactant | 0.2 | parts |
| (FUTARGENT 310 from NEOS) | | |
| Ion-exchange water | 70 | parts |
| Methanol | 30 | parts |

The thus prepared toner of Comparative Example 1 was also evaluated in the same way as mentioned in Example 1. The results are shown in Tables 1 and 2.

### Comparative Example 2

The procedure for preparation of the toner in Example 1 was repeated except that zinc stearate was not added in the dry external addition process.

The thus prepared toner of Comparative Example 2 was also evaluated in the same way as mentioned in Example 1. The results are shown in Tables 1 and 2.

### Comparative Example 3

The procedure for preparation of the toner in Example 1 was repeated except that the silica X-24 was not added in the wet external addition process and the silica was added in the dry external addition process together with the other external additives (hydrophobized silica, hydrophobized titanium oxide and zinc stearate).

The thus prepared toner of Comparative Example 3 was also evaluated in the same way as mentioned in Example 1. The results are shown in Tables 1 and 2.

### Comparative Example 4

The procedure for preparation of the toner in Example 1 was repeated except that the photoreceptor did not have the protective layer (which includes the friction coefficient decreasing agent).

The thus prepared toner of Comparative Example 4 was also evaluated in the same way as mentioned in Example 1. The results are shown in Tables 1 and 2.

### Comparative Example 5

The procedure for preparation of the toner in Example 1 was repeated except that zinc stearate was not added to the toner particles in the dry external addition process and the photoreceptor did not have the protective layer (which includes the friction coefficient decreasing agent).

The thus prepared toner of Comparative Example 5 was also evaluated in the same way as mentioned in Example 1. The results are shown in Tables 1 and 2.

TABLE 1

| | Particle diameter distribution of | | | |
|---|---|---|---|---|
| | toner | | | |
| | Volume | Number | | Shape of |
| | average | average | | toner |
| | particle | particle | | particles |
| | diameter | diameter | | Average |
| | (Dv) (μm) | (Dn) (μm) | Dv/Dn | circularity |
| Ex. 1 | 4.8 | 4.3 | 1.12 | 0.98 |
| Ex. 2 | 4.9 | 4.4 | 1.11 | 0.98 |
| Comp. Ex. 1 | 4.8 | 4.3 | 1.12 | 0.98 |
| Comp. Ex. 2 | 4.8 | 4.3 | 1.12 | 0.98 |
| Comp. Ex. 3 | 4.8 | 4.3 | 1.12 | 0.98 |
| Comp. Ex. 4 | 4.8 | 4.3 | 1.12 | 0.98 |
| Comp. Ex. 5 | 4.8 | 4.3 | 1.12 | 0.98 |

TABLE 2

| | | Static friction coefficient | |
|---|---|---|---|
| | | Before running | After running |
| | Cleanability | test | test |
| Ex. 1 | ◯ | 0.26 | 0.31 |
| Ex. 2 | ⊚ | 0.26 | 0.28 |
| Comp. Ex. 1 | Δ | 0.26 | 0.35 |
| Comp. Ex. 2 | X | 0.26 | 0.43 |
| Comp. Ex. 3 | X | 0.26 | 0.38 |
| Comp. Ex. 4 | Δ | 0.53 | 0.48 |
| Comp. Ex. 5 | X | 0.26 | 0.61 |

As can be understood from Tables 1 and 2, the following knowledges are obtained.

By using the combination of the toner and the photoreceptor prepared in Example 1, particles of the toner remaining on the surface of the photoreceptor can be well removed. In addition, the surface of the photoreceptor has a low static friction coefficient, 0.31, even after the 1,000,000-copy running test, and therefore toner particles remaining on the surface of the photoreceptor can be well removed. Further, by using the combination, high quality images can be produced even after the 100,000-copy running test.

Since heating is performed on the toner after the wet external addition process, the particulate silica can be securely fixed on the toner particles and therefore the toner has excellent cleanability.

In contrast, since the wet external addition process is not carried out in Comparative Example 1, the cleanability of the toner is clearly inferior to those of the toners of Examples 1 and 2. Since the static friction coefficient of the photoreceptor is greater than 0.40 in Comparative Example 2, the cleanability of the toner is much worse than those of the toners of Examples 1 and 2. Since the wet external addition process is not carried out in Comparative Example 3, the cleanability of the toner is much worse than those of the toners of Examples 1 and 2. Since the static friction coefficient of the photoreceptor is greater than 0.40 in Comparative Examples 4 and 5, the cleanability of the toner is much worse than those of the toners of Examples 1 and 2.

As can be clearly understood from the above description, the toner of the present invention has good cleanability even when a cleaning method such as blade cleaning is performed because it is prevented that particles of the toner remaining on a surface of an image bearing member pass through the nip between the cleaning blade and the image bearing member. Therefore, high quality images without background development can be produced.

In addition, by using the image forming method, the image forming apparatus and the process cartridge of the present invention, high quality images without background development can be produced.

Further, by using the toner manufacturing method of the present invention, the toner of the present invention can be efficiently produced.

This document claims priority and contains subject matter related to Japanese Patent Application No. 2003-349108 filed on Oct. 8, 2003, incorporated herein by reference.

Having now fully described the invention, it will be apparent to one of ordinary skill in the art that many changes and modifications can be made thereto without departing from the spirit and scope of the invention as set forth therein.

1. An image forming method comprising:
forming an electrostatic latent image on an image bearing member;
developing the electrostatic latent image with a developer comprising a toner to prepare a toner image on a surface of the image bearing member;
transferring the toner image onto a receiving material; and
cleaning the surface of the image bearing member with a cleaning blade;
wherein the surface of the image bearing member has a static friction coefficient of from 0.10 to 0.40, and wherein the toner has an average circularity of from 0.97 to 1.00 and comprises toner particles and a particulate material having an average particle diameter of from 0.03 to 1 μm, wherein the particulate material is externally added to the toner particles in a liquid.

2. The image forming method according to claim 1, wherein the image bearing member comprises a material selected from the group consisting of fluorine-containing resins, derivatives of fluorine-containing resins, silicone resins, and derivatives of silicone resins.

3. The image forming method according to claim 1, wherein the particulate material comprises a particulate inorganic material.

4. The image forming method according to claim 3, wherein the particulate inorganic material is a hydrophobized inorganic material.

5. The image forming method according to claim 1, wherein the toner has a volume average particle diameter of from 1 to 8 μm.

6. The image forming method according to claim 1, wherein the toner further comprises a cleanability improving agent.

7. The image forming method according to claim 6, wherein the cleanability improving agent is a material selected from the group consisting of fatty acid metal salts and particulate polymers.

8. The image forming method according to claim 1, wherein the toner further comprises a fluidity improving agent, and wherein the fluidity improving agent is externally added to the toner particles by a dry method.

9. The image forming method according to claim 1, wherein the toner particles are prepared by a method comprising:
reacting a compound having an active hydrogen with a polymer in an aqueous medium while granulating a reaction product of the compound and the polymer.

10. A toner comprising:
toner particles; and
a particulate material which is present on at least a surface of the toner particles and has an average particle diameter of from 0.03 to 1 μm,
wherein the toner has an average circularity of from 0.97 to 1.00, and wherein the particulate material is externally added to the toner particles in a liquid.

11. The toner according to claim 10, wherein the particulate material comprises a particulate inorganic material.

12. The toner according to claim 11, wherein the particulate inorganic material is a hydrophobized inorganic material.

13. The toner according to claim 10, wherein the toner has a volume average particle diameter of from 1 to 8 μm.

14. The toner according to claim 10, further comprising a cleanability improving agent.

15. The toner according to claim 14, wherein the cleanability improving agent is a material selected from the group consisting of fatty acid metal salts and particulate polymers.

16. The toner according to claim 10, further comprising a fluidity improving agent, wherein the fluidity improving agent is externally added to the toner particles by a dry method.

17. The toner according to claim 10, wherein the toner particles are prepared by a method comprising:
reacting a compound having an active hydrogen with a polymer in an aqueous medium while granulating the resultant reaction product of the compound and the polymer.

18. A developer comprising the toner according to claim 10 and a carrier.

19. A method for preparing the toner according to claim 10, comprising:
providing toner particles; and
externally adding the particulate material by a wet method in the presence of a surfactant having a polarity different from a polarity of a surface of the toner particles.

20. The method according to claim 19, further comprising:
heating the toner particles after externally adding the particulate material thereto.

21. The method according to claim 19, wherein the surfactant comprises a fluorine-containing surfactant.

22. A container containing the toner according to claim 10.

23. An image forming apparatus comprising:
an image bearing member configured to bear an electrostatic latent image thereon;
a developing device configured to develop the electrostatic latent image with a developer including the toner according to claim 10 to form a toner image on a surface of the image bearing member; and
a cleaner configured to clean the surface of the image bearing member with a blade,
wherein the surface of the image bearing member has a static friction coefficient of from 0.10 to 0.40.

24. A process cartridge comprising:
an image bearing member which has a surface with a static friction coefficient of from 0.10 to 0.40 and which is configured to bear an electrostatic latent image; and
a developing device configured to develop the electrostatic latent image with a developer including the toner according to claim 10.
